(19) United States
(12) Patent Application Publication
(10) Pub. No.: US 2026/0093097 A1
(43) Pub. Date: Apr. 2, 2026

(54) OPTICAL PHOTOGRAPHIC LENS ASSEMBLY

(71) Applicant: ZHEJIANG SUNNY OPTICS CO., LTD., Ningbo (CN)

(72) Inventors: Qiuxia WU, Yuyao City (CN); Qi MENG, Yuyao City (CN); Litong SONG, Yuyao City (CN); Lin HUANG, Yuyao City (CN); Weifang LI, Yuyao City (CN); Yinfang JIN, Yuyao City (CN)

(73) Assignee: ZHEJIANG SUNNY OPTICS CO., LTD., Ningbo (CN)

(21) Appl. No.: 19/253,027

(22) Filed: Jun. 27, 2025

(30) Foreign Application Priority Data
Sep. 27, 2024 (CN) 202411366152.3

(51) Int. Cl. G02B 13/18; G02B 9/64

(52) U.S. Cl. CPC G02B 13/18; G02B 9/64

(57) ABSTRACT

The disclosure discloses an optical photographic lens assembly, including a first lens to a seventh lens, which are sequentially arranged from an object side to an image side along an optical axis; a fourth spacing element in contact with an image-side surface of a fourth lens is disposed between the fourth lens and a fifth lens; and a maximum thickness CP4 of the fourth spacing element along the optical axis, an air gap T45 between the fourth lens and the fifth lens on the optical axis, a radius of curvature R8 of an image-side surface of the fourth lens, an inner diameter d4s of an object-side surface of the fourth spacing element, a radius of curvature R9 of an object-side surface of the fifth lens, and an inner diameter d4m of the image-side surface of the fourth spacing element satisfy: 3.85<CP4/T45<19.6, −1.0<R8/d4s<−0.4, and 2.15<|R9/d4m|<2.55.

### CROSS-REFERENCE TO RELATED APPLICATION(S)

This disclosure claims priority to Chinese Patent Application No. 202411366152.3 filed on Sep. 27, 2024, the entire contents of each of which are incorporated herein by reference for all purposes. No new matter has been introduced.

### FIELD

The disclosure relates to the field of optical elements, and particularly relates to an optical photographic lens assembly.

### BACKGROUND

Nowadays, people are becoming more and more accustomed to recording and sharing their lives through video shooting, many products on the market, such as mobile phones, cameras, sports cameras and the like, may be used for such photographing requirements, wherein although mobile phone photographing is convenient, its image quality, image stabilization performance, functionality and the like are not as good as those of professional handheld photographing devices, such as mirrorless cameras, however, these cameras have excessively large volumes and worse portability; and a handheld gimbal camera well solves the contradiction points of the above-mentioned products, not only has an excellent picture quality, but also has a volume small enough to be put into a pocket of clothing. As a main medium for picture capture, a main photographic lens of the device needs to have high pixels, small distortion, excellent anti-glare performance and other main properties to well achieve a photographing function required by people.

### SUMMARY

Some embodiments of the disclosure provide an optical photographic lens assembly. The optical photographic lens assembly may include a lens group and at least one spacing element, wherein the lens group may include a first lens, a second lens, a third lens, a fourth lens, a fifth lens, a sixth lens and a seventh lens, which are sequentially arranged from an object side to an image side along an optical axis, and there is an air gap between any two adjacent lenses among the first lens to the seventh lens; the first lens to the seventh lens include at least one aspheric lens; there are seven lenses having refractive powers in the optical photographic lens assembly; and the at least one spacing element includes a fourth spacing element, located between the fourth lens and the fifth lens and in contact with an image-side surface of the fourth lens. The optical photographic lens assembly satisfies conditional expressions: 3.85<CP4/T45<19.6, −1.0<R8/d4s<−0.4, and 2.15<|R9/d4m|<2.55, wherein CP4 is a maximum thickness of the fourth spacing element along the optical axis, T45 is an air gap between the fourth lens and the fifth lens on the optical axis, R8 is a radius of curvature of the image-side surface of the fourth lens, d4s is an inner diameter of an object-side surface of the fourth spacing element, R9 is a radius of curvature of an object-side surface of the fifth lens, and d4m is an inner diameter of the image-side surface of the fourth spacing element.

In one implementation, the at least one spacing element further includes a second spacing element, located between the second lens and the third lens and in contact with an image-side surface of the second lens, and a center thickness CT2 of the second lens on the optical axis, an air gap T23 between the second lens and the third lens on the optical axis, and a maximum thickness CP2 of the second spacing element along the optical axis satisfies: 1.1<CT2/(T23+CP2)≤4.4. In one implementation, the at least one spacing element further includes a first spacing element, located between the first lens and the second lens and in contact with an image-side surface of the first lens; and a radius of curvature R1 of an object-side surface of the first lens, a refractive index N1 of the first lens, and an inner diameter d1s of an object-side surface of the first spacing element satisfies: 1.4<|R1×N1|/d1s<6.5.

In one implementation, the optical photographic lens assembly further includes a lens barrel, and the lens group and the at least one spacing element are assembled in the lens barrel; the at least one spacing element further includes a first spacing element, located between the first lens and the second lens and in contact with the image-side surface of the first lens; and a distance EP01 from an object-side end surface of the lens barrel to the object-side surface of the first spacing element on the optical axis, a center thickness CT1 of the first lens on the optical axis, and an air gap T12 between the first lens and the second lens on the optical axis satisfies: 0.1≤(EP01−CT1)/(CT1+T12)≤0.4.

In one implementation, the at least one spacing element further includes a first spacing element, located between the first lens and the second lens and in contact with the image-side surface of the first lens; and a radius of curvature R2 of the image-side surface of the first lens and an outer diameter D1s of the object-side surface of the first spacing element satisfies: 1.05<|R2/D1s|<4.3.

In one implementation, the at least one spacing element further includes a first spacing element, located between the first lens and the second lens and in contact with the image-side surface of the first lens, and a second spacing element, located between the second lens and the third lens and in contact with the image-side surface of the second lens; and a radius of curvature R3 of an object-side surface of the second lens, an outer diameter D2s of an object-side surface of the second spacing element, and an outer diameter D1m of an image-side surface of the first spacing element satisfies: 7.3<R3/(D2s−D1m)<15.4.

In one implementation, the at least one spacing element further includes a second spacing element, located between the second lens and the third lens and in contact with the image-side surface of the second lens, and a third spacing element, located between the third lens and the fourth lens and in contact with an image-side surface of the third lens; and an effective focal length f3 of the third lens, a center thickness CT3 of the third lens on the optical axis, a maximum thickness CP2 of the second spacing element along the optical axis, and a maximum thickness CP3 of the third spacing element along the optical axis satisfies: −39.1<f3/(CT3+CP2+CP3)≤−11.0. In one implementation, the first lens has a positive refractive power or a negative refractive power; the second lens has a positive refractive power or a negative refractive power, and an object-side surface of the second lens is a convex surface; the third lens has a negative refractive power, and an object-side surface of the third lens is a concave surface; the fourth lens has a positive refractive power, and the image-side surface of the fourth lens is a convex surface; the fifth lens has a positive refractive power, and an image-side surface of the fifth lens is a convex surface; the sixth lens has a negative refractive power, an object-side surface of the sixth lens is a convex surface, and an image-side surface of the sixth lens is a concave surface; and the seventh lens has a negative refractive power.

In one implementation, the at least one spacing element further includes a third spacing element, located between the third lens and the fourth lens and in contact with the image-side surface of the third lens, and the fourth spacing element, located between the fourth lens and the fifth lens and in contact with the image-side surface of the fourth lens; and a radius of curvature R7 of an object-side surface of the fourth lens, a radius of curvature R6 of the image-side surface of the third lens, the inner diameter d4s of the object-side surface of the fourth spacing element and the inner diameter d3m of an image-side surface of the third spacing element satisfies: 1.35<|R7/R6|×(d4s/d3m)≤2.4.

In one implementation, the at least one spacing element further includes a third spacing element, located between the third lens and the fourth lens and in contact with the image-side surface of the third lens, and the fourth spacing element, located between the fourth lens and the fifth lens and in contact with the image-side surface of the fourth lens; and a center thickness CT4 of the fourth lens on the optical axis, a distance EP34 from the image-side surface of the third spacing element to the object-side surface of the fourth spacing element on the optical axis, and the maximum thickness CP4 of the fourth spacing element along the optical axis satisfies: 0.7<CT4/(EP34+CP4)<1.05.

In one implementation, the at least one spacing element further includes the fourth spacing element, located between the fourth lens and the fifth lens and in contact with the image-side surface of the fourth lens, and a fifth spacing element, located between the fifth lens and the sixth lens and in contact with the image-side surface of the fifth lens; and a distance EP45 from the image-side surface of the fourth spacing element to an object-side surface of the fifth spacing element on the optical axis, a maximum thickness CP5 of the fifth spacing element along the optical axis, and a center thickness CT5 of the fifth lens on the optical axis satisfies: 0.8<(EP45+CP5)/CT5<2.3.

In one implementation, the at least one spacing element further includes a fifth spacing element, located between the fifth lens and the sixth lens and in contact with the image-side surface of the fifth lens; and a radius of curvature R11 of the object-side surface of the sixth lens, an inner diameter d5s of the object-side surface of the fifth spacing element, and an inner diameter d5m of an image-side surface of the fifth spacing element satisfies: 5.8<R11/|d5s−d5m|<11.6. In one implementation, the at least one spacing element further includes a fifth spacing element, located between the fifth lens and the sixth lens and in contact with the image-side surface of the fifth lens; and a radius of curvature R12 of the image-side surface of the sixth lens and an outer diameter D5m of the image-side surface of the fifth spacing element satisfies: 0.25<R12/D5m<0.6.

In one implementation, the at least one spacing element further includes a fifth spacing element, located between the fifth lens and the sixth lens and in contact with the image-side surface of the fifth lens, and a sixth spacing element, located between the sixth lens and the seventh lens and in contact with the image-side surface of the sixth lens; and an air gap T67 between the sixth lens and the seventh lens on the optical axis, a distance EP56 from the image-side surface of the fifth spacing element to an object-side surface of the sixth spacing element on the optical axis, and a center thickness CT7 of the seventh lens on the optical axis satisfies: 4.1<T67/EP56+T67/CT7<6.3.

In one implementation, an effective focal length f6 of the sixth lens and an effective focal length f7 of the seventh lens satisfies: 0.33<f6/f7≤2.0.

In an embodiment, the at least one spacing element further includes a sixth spacing element, located between the sixth lens and the seventh lens and in contact with the image-side surface of the sixth lens; and a radius of curvature R13 of an object-side surface of the seventh lens and an inner diameter d6m of an image-side surface of the sixth spacing element satisfies: 0.45<|R13/d6m|≤0.7.

In one implementation, the at least one spacing element further includes a sixth spacing element, located between the sixth lens and the seventh lens and in contact with the image-side surface of the sixth lens; and a radius of curvature R14 of an image-side surface of the seventh lens, an outer diameter Dom of the image-side surface of the sixth spacing element, and the inner diameter d6m of the image-side surface of the sixth spacing element satisfies: 1.14<|R14|/(D6m−d6m)≤1.85. The optical photographic lens assembly according to the implementations of the disclosure includes the lens group and the at least one spacing element, the lens group includes the first lens to the seventh lens that are sequentially arranged from the object side to the image side along the optical axis, and there is the air gap between any two adjacent lenses; the first lens to the seventh lens include at least one aspheric lens; there are seven lenses having refractive powers in the optical photographic lens assembly; the at least one spacing element includes the fourth spacing element, located between the fourth lens and the fifth lens and in contact with the image-side surface of the fourth lens; the maximum thickness CP4 of the fourth spacing element along the optical axis and the air gap T45 between the fourth lens and the fifth lens on the optical axis satisfy the conditional expression 3.85<CP4/T45<19.6; the radius of curvature R8 of the image-side surface of the fourth lens and the inner diameter d4s of the object-side surface of the fourth spacing element satisfy the conditional expression −1.0<R8/d4s<−0.4; the radius of curvature R9 of the object-side surface of the fifth lens and the inner diameter d4m of the image-side surface of the fourth spacing element satisfy the conditional expression 2.15<|R9/d4m|<2.55. By means of such settings of the optical photographic lens assembly, the lens is able to achieve the technical features of high pixels and small distortion, wherein a ratio of the maximum thickness CP4 of the fourth spacing element along the optical axis to the air gap between the fourth lens and the fifth lens satisfies the foregoing conditional expression 3.85<CP4/T45<19.6, which means that the span of effective diameter edges of the fourth lens and the fifth lens is relatively large and thus a relatively thick spacing element needs to be disposed herein for spacing, however the angles of rays of an edge field of view herein is relatively steep, resulting in a certain risk of reflecting stray light on an inner-diameter inclined ring surface of the spacing element in the case of incidence of large-angle incident light rays; and meanwhile, by means of controlling the satisfaction of the conditional expressions −1.0<R8/d4s<−0.4 and 2.15<|R9/d4m|<2.55, the stray light is able to be effectively controlled, thereby achieving an inhibitory effect.

### BRIEF DESCRIPTION OF DRAWINGS

Other features, objectives and advantages of the disclosure will become more apparent upon reading the detailed description of non-limiting embodiments with reference to the following drawings. In the drawings:

FIG. 1 illustrates a schematic diagram of a structure and related parameters of an optical photographic lens assembly according to an exemplary implementation of the disclosure;

FIG. 2 illustrates a schematic structural diagram of an optical photographic lens assembly according to Embodiment 1 of the disclosure;

FIG. 3 illustrates a schematic structural diagram of an optical photographic lens assembly according to Embodiment 2 of the disclosure;

FIGS. 4 to 7 respectively illustrate longitudinal aberration curves, astigmatism curves, a distortion curve and a lateral color curve of the optical imaging lenses according to Embodiment 1 and Embodiment 2 of the disclosure;

FIG. 8 illustrates a schematic structural diagram of an optical photographic lens assembly according to Embodiment 3 of the disclosure;

FIG. 9 illustrates a schematic structural diagram of an optical photographic lens assembly according to Embodiment 4 of the disclosure;

FIGS. 10 to 13 respectively illustrate longitudinal aberration curves, astigmatism curves, a distortion curve and a lateral color curve of the optical imaging lenses according to Embodiment 3 and Embodiment 4 of the disclosure;

FIG. 14 illustrates a schematic structural diagram of an optical photographic lens assembly according to Embodiment 5 of the disclosure;

FIG. 15 illustrates a schematic structural diagram of an optical photographic lens assembly according to Embodiment 6 of the disclosure;

FIGS. 16 to 19 respectively illustrate longitudinal aberration curves, astigmatism curves, a distortion curve and a lateral color curve of the optical imaging lenses according to Embodiment 5 and Embodiment 6 of the disclosure;

FIG. 20 illustrates a light spot condition formed by reflecting stray light on an inner-diameter inclined ring surface of a fourth spacing element, when an optical photographic lens assembly according to an exemplary implementation of the disclosure satisfies a conditional expression R8/d4s=−0.2;

FIG. 21 illustrates a schematic diagram of an incidence direction and a reflection direction of light rays on an inner-diameter inclined ring surface of a fourth spacing element, when an optical photographic lens assembly according to an exemplary implementation of the disclosure satisfies a conditional expression R8/d4s=−0.2;

FIG. 22 illustrates a light spot condition formed by reflecting stray light on an inner-diameter inclined ring surface of a fourth spacing element, when an optical photographic lens assembly according to an exemplary implementation of the disclosure satisfies a conditional expression R8/d4s=−0.7;

FIG. 23 illustrates a schematic diagram of an incidence direction and a reflection direction of light rays on an inner-diameter inclined ring surface of a fourth spacing element, when an optical photographic lens assembly according to an exemplary implementation of the disclosure satisfies a conditional expression R8/d4s=−0.7;

FIG. 24 illustrates a light spot condition formed by reflecting stray light on an inner-diameter inclined ring surface of a fourth spacing element, when an optical photographic lens assembly according to an exemplary implementation of the disclosure satisfies a conditional expression R8/d4s=−1.2;

FIG. 25 illustrates a schematic diagram of an incidence direction and a reflection direction of light rays on an inner-diameter inclined ring surface of a fourth spacing element, when an optical photographic lens assembly according to an exemplary implementation of the disclosure satisfies a conditional expression R8/d4s=−1.2.

### DESCRIPTION OF EMBODIMENTS

For a better understanding of the disclosure, various aspects of the disclosure will be described in more detail with reference to the drawings. It should be understood that these detailed descriptions are merely descriptions of exemplary implementations of the disclosure, and are not intended to limit the scope of the disclosure in any way. Throughout the specification, the same reference signs refer to the same elements. The expression “and/or” includes any and all combinations of one or more of associated listed items.

It should be noted that in the present specification, expressions such as first, second and third are only used to distinguish one feature from another feature, but do not indicate any limitation to the features. Therefore, without departing from the teachings of the disclosure, a first lens discussed below may also be referred to as a second lens or a third lens.

In the drawings, for ease of description, the thickness, size and shape of the lens have been slightly exaggerated. Specifically, the shape of a spherical surface or an aspheric surface shown in the drawings is shown by way of example. That is, the shape of the spherical surface or the aspheric surface is not limited to the shape of the spherical surface or the aspheric surface shown in the drawings. The drawings are merely examples and are not strictly drawn to scale.

Herein, a paraxial region refers to a region in the vicinity of an optical axis. If the surface of a lens is a convex surface and the position of the convex surface is not defined, it indicates that the surface of the lens is a convex surface at least in the paraxial region; and if the surface of the lens is a concave surface and the position of the concave surface is not defined, it indicates that the surface of the lens is a concave surface at least in the paraxial region. The surface shape in the paraxial region may be judged according to a general method in the art, for example, the concave-convex shape is judged by positive and negative properties of an R value (R refers to a radius of curvature of the paraxial region). Herein, the surface of each lens closest to a photographed object is referred to as an object-side surface of the lens, and the surface of each lens closest to an imaging surface of the optical photographic lens assembly is referred to as an image-side surface of the lens. For the object-side surface, when the R value is positive, it is judged that the object-side surface is a convex surface, and when the R value is negative, it is judged that the object-side surface is a concave surface; and for the image-side surface, when the R value is positive, it is judged that the image-side surface is a concave surface, and when the R value is negative, it is judged that the image-side surface is a convex surface.

The solutions in the embodiments of the disclosure may be simulated by using software/tools such as ZEMAX and CODE V, and the solutions in some embodiments may be preferably simulated by using CODE V as an example. During simulation by using such software/tools, the surface shape of the surface of the lens may be appropriately adjusted according to an own surface shape model of the software/tool used.

It should also be understood that, the terms “comprise”, “including”, “have”, “contain” and/or “containing”, when used in the present specification, indicate the presence of stated features, elements and/or components, but do not preclude the presence or addition of one or more other features, elements, components and/or combinations thereof. In addition, when an expression such as “at least one of . . . ” occurs after a list of listed features, the expression modifies the entire list of features, rather than modifying individual elements in the list. In addition, when the implementations of the disclosure are described, “may” is used to indicate “one or more implementations of the disclosure”. Moreover, the term “exemplary” is intended to refer to an example or illustration.

Unless otherwise defined, all terms (including technical terms and scientific terms) used herein have the same meanings as commonly understood by those ordinary skilled in the art to which the disclosure belongs. It should also be understood that terms (e.g., terms defined in commonly used dictionaries) should be interpreted as having meanings consistent with those in the context of related art and will not be interpreted in an idealized or overly formal sense, unless expressly so defined herein.

It should be noted that, in the case of no conflict, embodiments in the disclosure and features in the embodiments may be combined with each other. The following embodiments only express several implementations of the disclosure, and the description thereof is relatively specific and detailed, but may not be understood as limitations to the patent scope of the disclosure. It should be pointed out that, for those ordinary skilled in the art, several modifications and improvements may also be made without departing from the concept of the disclosure, and all these modifications and improvements fall within the protection scope of the disclosure, for example, a lens group, a lens barrel and a spacing element in various embodiments of the disclosure may be arbitrarily combined, and it is not limited to that the lens group in one embodiment may only be combined with the lens barrel, the spacing element and the like in the embodiment.

The features, principles and other aspects of the disclosure will be described below in detail. An optical photographic lens assembly according to an exemplary implementation of the disclosure includes a lens group and at least one spacing element. The lens group may be a seven-piece lens group, including a first lens, a second lens, a third lens, a fourth lens, a fifth lens, a sixth lens, and a seventh lens. In an exemplary implementation, the first lens to the seventh lens are sequentially arranged from an object side to an image side along an optical axis.

In an exemplary implementation, there is an air gap between any two adjacent lenses among the first lens to the seventh lens.

In an exemplary implementation, the first lens to the seventh lens includes at least one aspheric lens. The aspheric lens has better curvature radius characteristics, and has the advantages of improving distortion aberration and improving astigmatism aberration. By using the aspheric lens, aberrations appearing during imaging are able to be eliminated as much as possible, thereby improving the imaging quality.

In an exemplary implementation, there are seven lenses having refractive powers in the optical photographic lens assembly.

In an exemplary implementation, the at least one spacing element in the optical photographic lens assembly includes a fourth spacing element, located between the fourth lens and the fifth lens and in contact with an image-side surface of the fourth lens.

In an exemplary implementation, the optical photographic lens assembly of the disclosure satisfies a conditional expression 3.85<CP4/T45<19.6, wherein CP4 is a maximum thickness of the fourth spacing element along the optical axis, and T45 is an air gap between the fourth lens and the fifth lens on the optical axis. The maximum thickness of the fourth spacing element is the maximum thickness of the fourth spacing element in a direction of the optical axis or a direction parallel to the optical axis, and the air gap between the fourth lens and the fifth lens on the optical axis is a distance from the image-side surface of the fourth lens to an object-side surface of the fifth lens on the optical axis.

In an exemplary implementation, the optical photographic lens assembly of the disclosure satisfies a conditional expression −1.0<R8/d4s<−0.4, wherein R8 is a radius of curvature of the image-side surface of the fourth lens, d4s is an inner diameter of an object-side surface of the fourth spacing element.

In an exemplary implementation, the optical photographic lens assembly of the disclosure satisfies a conditional expression 2.15<|R9/d4m|<2.55, wherein R9 is a radius of curvature of the object-side surface of the fifth lens, and d4m is an inner diameter of an image-side surface of the fourth spacing element.

The optical photographic lens assembly according to the implementations of the disclosure includes the lens group and the at least one spacing element, the lens group includes the first to seventh lenses that are sequentially arranged from the object side to the image side along the optical axis, and there is the air gap between any two adjacent lenses; the first lens to the seventh lens include at least one aspheric lens; there are seven lenses having refractive powers in the optical photographic lens assembly; the at least one spacing element includes the fourth spacing element, located between the fourth lens and the fifth lens and in contact with the image-side surface of the fourth lens; the maximum thickness CP4 of the fourth spacing element along the optical axis and the air gap T45 between the fourth lens and the fifth lens on the optical axis satisfy the conditional expression 3.85<CP4/T45<19.6; the radius of curvature R8 of the image-side surface of the fourth lens and the inner diameter d4s of the object-side surface of the fourth spacing element satisfy the conditional expression −1.0<R8/d4s<−0.4; the radius of curvature R9 of the object-side surface of the fifth lens and the inner diameter d4m of the image-side surface of the fourth spacing element satisfy the conditional expression 2.15<|R9/d4m|<2.55. By means of such settings of the optical photographic lens assembly, the lens is able to achieve the technical features of high pixels and small distortion, wherein a ratio of the maximum thickness CP4 of the fourth spacing element along the optical axis to the air gap between the fourth lens and the fifth lens satisfies the foregoing conditional expression 3.85<CP4/T45<19.6, which means that the span of effective diameter edges of the fourth lens and the fifth lens is relatively large and thus a relatively thick spacing element (i.e., the fourth spacing element) needs to be disposed herein for spacing, however the angles of rays of an edge field of view herein is relatively steep, resulting in a certain risk of reflecting stray light on an inner-diameter inclined ring surface of the fourth spacing element in the case of incidence of large-angle incident light rays; and meanwhile, by means of controlling the satisfaction of the conditional expressions −1.0<R8/d4s<−0.4 and 2.15<|R9/d4m|<2.55, the stray light is able to be effectively controlled, thereby achieving an inhibitory effect.

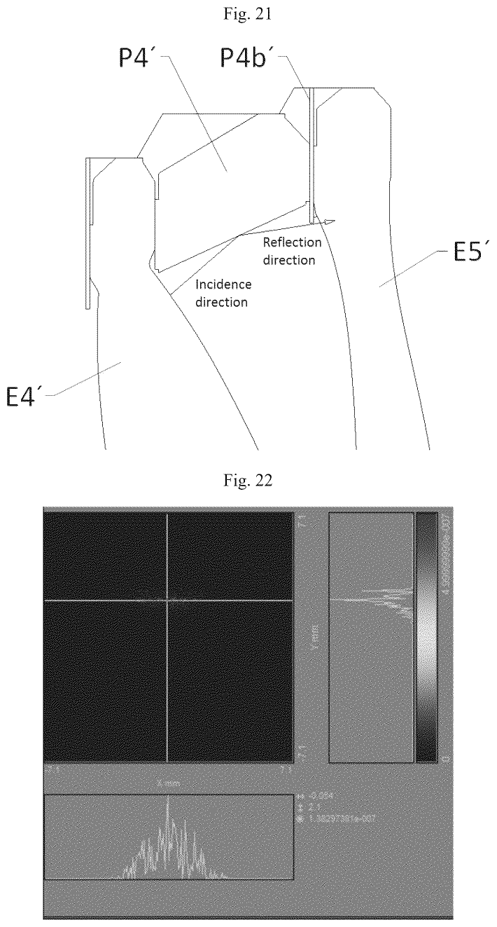

FIG. 20 and FIG. 21 respectively illustrate a light spot condition formed by reflecting stray light on an inner-diameter inclined ring surface of a fourth spacing element P4′ and a schematic diagram of an incidence direction and a reflection direction of light rays on the inner-diameter inclined ring surface of the fourth spacing element P4′, when an optical photographic lens assembly according to an exemplary implementation of the disclosure satisfies a conditional expression R8/d4s=−0.2. It can be seen from FIG. 21 that, for example, the fourth spacing element P4′ and a fourth auxiliary spacing element P4′b are disposed between a fourth lens E4′ and a fifth lens E5′, wherein an object-side surface of the fourth spacing element P4′ is in direct contact with an image-side surface of the fourth lens E4′, the fourth auxiliary spacing element P4′b is located between the fourth spacing element P4′ and the fifth lens E5′, and an image-side surface of the fourth auxiliary spacing element P4′b is in direct contact with an object-side surface of the five lens E5′; and the incidence direction of light rays, for example, in an edge field of view, emitted from the fourth lens E4′ entering the inner-diameter inclined ring surface of the fourth spacing element P4′, and the reflection direction of the rays after being reflected by the inner-diameter inclined ring surface of the fourth spacing element P4′ are as shown in FIG. 21, it can be seen that the reflected rays are not intercepted by, for example, the fourth auxiliary spacing element P4′b and are further incident into a rear optical system to form stray light. It can be seen from FIG. 20 that light spots formed by the reflection of the inner diameter of the fourth spacing element P4′ have greater areas and higher intensities, which are approximate to threshold values.

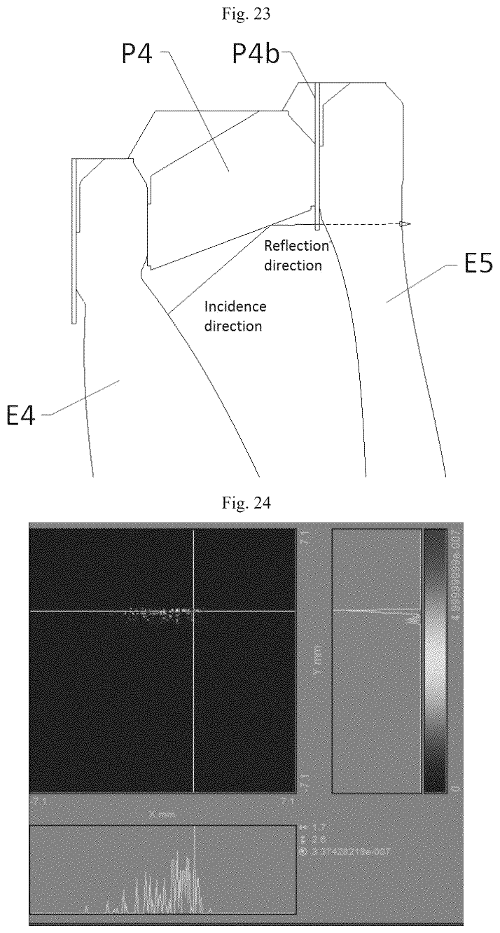

FIG. 22 and FIG. 23 respectively illustrate a light spot condition formed by reflecting stray light on an inner-diameter inclined ring surface of a fourth spacing element P4 and a schematic diagram of an incidence direction and a reflection direction of light rays on the inner-diameter inclined ring surface of the fourth spacing element P4, when an optical photographic lens assembly according to an exemplary implementation of the disclosure satisfies a conditional expression R8/d4s=−0.7. It can be seen from FIG. 23 that, for example, the fourth spacing element P4 and a fourth auxiliary spacing element P4b are disposed between a fourth lens E4 and a fifth lens E5, wherein an object-side surface of the fourth spacing element P4 is in direct contact with an image-side surface of the fourth lens E4, the fourth auxiliary spacing element P4b is located between the fourth spacing element P4 and the fifth lens E5, and an image-side surface of the fourth auxiliary spacing element P4b is in direct contact with an object-side surface of the five lens E5; and the incidence direction of light rays, for example, in an edge field of view, emitted from the fourth lens E4 entering the inner-diameter inclined ring surface of the fourth spacing element P4, and the reflection direction of the rays after being reflected by the inner-diameter inclined ring surface of the fourth spacing element P4 are as shown in FIG. 23, it can be seen that the reflected rays is effectively intercepted/shielded by, for example, the fourth auxiliary spacing element P4b and are no longer further incident into the rear optical system, so that the formation of stray light is able to be effectively avoided or reduced. It can be seen from FIG. 22 that light spots formed by the reflection of the inner diameter of the fourth spacing element P4 have smaller areas and lower intensities.

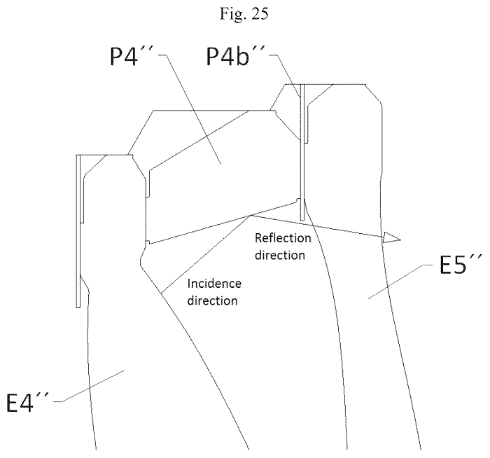

FIG. 24 and FIG. 25 respectively illustrate a light spot condition formed by reflecting stray light on an inner-diameter inclined ring surface of a fourth spacing element P4″ and a schematic diagram of an incidence direction and a reflection direction of light rays on the inner-diameter inclined ring surface of the fourth spacing element P4″, when an optical photographic lens assembly according to an exemplary implementation of the disclosure satisfies a conditional expression R8/d4s=−1.2. It can be seen from FIG. 25 that, for example, the fourth spacing element P4″ and a fourth auxiliary spacing element P4″b are disposed between a fourth lens E4″ and a fifth lens E5″, wherein an object-side surface of the fourth spacing element P4″ is in direct contact with an image-side surface of the fourth lens E4″, the fourth auxiliary spacing element P4″b is located between the fourth spacing element P4″ and the fifth lens E5″, and an image-side surface of the fourth auxiliary spacing element P4″b is in direct contact with an object-side surface of the five lens E5″; and the incidence direction of light rays, for example, in an edge field of view, emitted from the fourth lens E4″ entering the inner-diameter inclined ring surface of the fourth spacing element P4″, and the reflection direction of the rays after being reflected by the inner-diameter inclined ring surface of the fourth spacing element P4″ are as shown in FIG. 25, it can be seen that the reflected rays are not intercepted by, for example, the fourth auxiliary spacing element P4″b and are further incident into the rear optical system to form stray light. It can be seen from FIG. 24 that light spots formed by the reflection of the inner diameter of the fourth spacing element P4″ also have greater areas and higher intensities.

It can be seen from comparison and analysis of the three above different cases in FIGS. 20 to 25 that, in the optical photographic lens assembly according to the exemplary implementations of the disclosure, by means of reasonably setting the refractive powers of the first lens to the seventh lens, reasonably disposing the fourth spacing element, making the lens satisfy the conditional expression 3.85<CP4/T45<19.6 and the conditional expression 2.15<|R9/d4m|<2.55, and meanwhile setting a ratio of the radius of curvature R8 of the image-side surface of the fourth lens to the inner diameter d4s of the object-side surface of the fourth spacing element to satisfy the range −1.0<R8/d4s<−0.4, it is possible to effectively control the risk in which during the incidence of large-angle incident light rays in the edge field of view between the fourth lens and the fifth lens, stray light is generated when the rays are reflected by the inner-diameter inclined ring surface of the thicker spacing element, which is disposed herein due to the relatively large span of the effective diameter edges of the fourth lens and the fifth lens, so that the generation of the stray light herein is obliviously inhibited, and the performance of the lens is improved.

In an exemplary implementation, the first lens has a positive refractive power or a negative refractive power. The second lens has a positive refractive power or a negative refractive power. The third lens has a negative refractive power. The fourth lens has a positive refractive power. The fifth lens has a positive refractive power. The sixth lens has a negative refractive power. The seventh lens has a negative refractive power.

In an exemplary implementation, an object-side surface of the first lens is a concave surface or a convex surface, and an image-side surface of the first lens is a convex surface or a concave surface. An object-side surface of the second lens is a convex surface, and an image-side surface of the second lens is a convex surface or a concave surface. An object-side surface of the third lens is a concave surface, and an image-side surface of the third lens is a convex surface or a concave surface. An object-side surface of the fourth lens is a convex surface or a concave surface, and an image-side surface of the fourth lens is a convex surface. An object-side surface of the fifth lens is a concave surface or a convex surface, and an image-side surface of the fifth lens is a convex surface. An object-side surface of the sixth lens is a convex surface, and an image-side surface of the sixth lens is a concave surface. An object-side surface of the seventh lens is a concave surface or a convex surface, and an image-side surface of the seventh lens is a convex surface or a concave surface.

In an exemplary implementation, the at least one spacing element in the optical photographic lens assembly further includes a first spacing element, located between the first lens and the second lens and in contact with the image-side surface of the first lens.

In an exemplary implementation, the at least one spacing element in the optical photographic lens assembly further includes a second spacing element, located between the second lens and the third lens and in contact with the image-side surface of the second lens.

In an exemplary implementation, the at least one spacing element in the optical photographic lens assembly further includes a third spacing element, located between the third lens and the fourth lens and in contact with the image-side surface of the third lens.

In an exemplary implementation, the at least one spacing element in the optical photographic lens assembly further includes a fifth spacing element, located between the fifth lens and the sixth lens and in contact with the image-side surface of the fifth lens.

In an exemplary implementation, the at least one spacing element in the optical photographic lens assembly further includes a sixth spacing element, located between the sixth lens and the seventh lens and in contact with the image-side surface of the sixth lens.

In an exemplary implementation, the optical photographic lens assembly further includes a lens barrel, and the lens group and the at least one spacing element are assembled in the lens barrel. In an exemplary implementation, the optical photographic lens assembly of the disclosure satisfies a conditional expression 1.1<CT2/(T23+CP2)≤4.4, wherein CT2 is a center thickness of the second lens on the optical axis, T23 is an air gap between the second lens and the third lens on the optical axis, and CP2 is a maximum thickness of the second spacing element along the optical axis. The maximum thickness of the second spacing element is the maximum thickness of the second spacing element in the direction of the optical axis or the direction parallel to the optical axis, and the air gap between the second lens and the third lens on the optical axis is a distance from the image-side surface of the second lens to the object-side surface of the third lens on the optical axis. By means of controlling the optical photographic lens assembly to satisfy the conditional expression 1.1<CT2/(T23+CP2)≤4.4, the center thickness of the second lens, the thickness of the second spacing element and the air gap between the second lens and the third lens are able to be directly controlled, thereby facilitating a thickness ratio of the center thickness of the second lens to an edge thickness, facilitating to ensure the molding feasibility of the second lens, and improving the forming stability of the second lens, and meanwhile, the strength of the second lens and the second spacing element are able to be effectively ensured to improve the assembly stability.

In an exemplary implementation, the optical photographic lens assembly of the disclosure satisfies a conditional expression 1.4<|R1×N1|/d1s<6.5, wherein R1 is a radius of curvature of the object-side surface of the first lens, N1 is a refractive index of the first lens, and d1s is an inner diameter of an object-side surface of the first spacing element. By means of controlling the optical photographic lens assembly to satisfy the conditional expression 1.4<|R1×N1|/d1s<6.5, the radius of curvature of the object-side surface and the refractive index of the first lens, and the inner diameter of the object-side surface of the first spacing element are able to be directly controlled, thereby facilitating to ensure the refraction angle of rays entering each field of view of the first lens, and meanwhile, due to the reasonable setting of the inner diameter of the first spacing element, a total reflection stray light path and a refraction stray light path generated by the structural portion of the first lens are able to be effectively avoided. In an embodiment, the R1, the N1 and the d1s satisfies: 1.45<R1×N1|/d1s<6.45. In another embodiment, the R1, the N1 and the d1s satisfies: 1.46≤|R1×N1|/d1s≤6.44.

In an exemplary implementation, the optical photographic lens assembly of the disclosure satisfies a conditional expression 0.1≤(EP01−CT1)/(CT1+T12)≤0.4, wherein EP01 is a distance from an object-side end surface of the lens barrel to the object-side surface of the first spacing element on the optical axis, CT1 is a center thickness of the first lens on the optical axis, and T12 is an air gap between the first lens and the second lens on the optical axis. The object-side end surface of the lens barrel is the surface or the end surface of the lens barrel that is closest to the object side and is perpendicular or approximately perpendicular to the optical axis; and the air gap between the first lens and the second lens on the optical axis is a distance from the image-side surface of the first lens to the object-side surface of the second lens on the optical axis. By means of controlling the optical photographic lens assembly to satisfy the conditional expression 0.1≤(EP01−CT1)/(CT1+T12)≤0.4, the thickness of a supporting surface on an object-side end of the lens barrel and the edge thickness and the center thickness of the first lens are able to be directly controlled, the thickness of the first spacing element is able to be indirectly controlled, the intensity of a supporting surface on a front end/object-side end of the lens barrel, and it is conducive to ensuring the reliability requirements of mechanical reliability such as stability and falling during an overall assembly process of the lens; and meanwhile, it is conducive to ensuring the edge thickness level of the first lens and the thickness of the first spacing element, and it is conducive to improving the structural stability of an assembly front end of the lens.

In an exemplary implementation, the optical photographic lens assembly of the disclosure satisfies a conditional expression 1.05<|R2/D1s|<4.3, wherein R2 is a radius of curvature of the image-side surface of the first lens, and D1s is an outer diameter of the object-side surface of the first spacing element. By means of controlling the optical photographic lens assembly to satisfy the conditional expression 1.05<|R2/D1s|<4.3, the radius of curvature of the image-side surface of the first lens and the outer diameter level of the first spacing element are able to be reasonably controlled, a refraction direction and a refraction angle of imaging rays in each field of view after passing through the first lens are able to be effectively ensured, meanwhile, the outer diameter level of the first spacing element is able to be used for controlling a stress moment during the assembly of the first spacing element, so as to reduce the impact thereon during the assembly of each component on the rear side and to improve the overall assembly stability of the lens.

In an exemplary implementation, the optical photographic lens assembly of the disclosure satisfies a conditional expression 7.3<R3/(D2s−D1m)<15.4, wherein R3 is a radius of curvature of the object-side surface of the second lens, D2s is an outer diameter of an object-side surface of the second spacing element, and D1m is an outer diameter of an image-side surface of the first spacing element. By means of controlling the optical photographic lens assembly to satisfy the conditional expression 7.3<R3/(D2s−D1m)<15.4, non-imaging light rays entering/exiting the second lens are able to be directly controlled, and inner apertures of the spacing elements in front of and behind the second lens are able to intercept transmitted stray light and internal reflected stray light of the second lens, thereby improving the glare level of the whole lens and improving the picture cleanliness.

In an exemplary implementation, the optical photographic lens assembly of the disclosure satisfies a conditional expression −39.1<f3/(CT3+CP2+CP3)≤−11.0, wherein f3 is an effective focal length of the third lens, CT3 is a center thickness of the third lens on the optical axis, CP2 is a maximum thickness of the second spacing element along the optical axis, and CP3 is a maximum thickness of the third spacing element along the optical axis. The maximum thickness of the third spacing element is the maximum thickness of the third spacing element in the direction of the optical axis or the direction parallel to the optical axis. By means of controlling the optical photographic lens assembly to satisfy the conditional expression −39.1<f3/(CT3+CP2+CP3)≤−11.0, effective control over the focal length of the third lens is able to be achieved, and meanwhile, the thickness of the second spacing element, the thickness of the third spacing element, and the center thickness of the third lens are able to be adjusted and controlled, thereby effectively ensuring that the thickness of the second spacing element and the thickness of the third spacing element are at a suitable level, enhancing the stability of the assembly, and improving the yield of an assembly manufacturing process. In an embodiment, the f3, the CT3, the CP2 and the CP3 satisfy: −39.1<f3/(CT3+CP2+CP3)≤−11.1.

In an exemplary implementation, the optical photographic lens assembly of the disclosure satisfies a conditional expression 1.35<|R7/R6|×(d4s/d3m)≤2.4, wherein R7 is a radius of curvature of the object-side surface of the fourth lens, R6 is a radius of curvature of the image-side surface of the third lens, d4s is the inner diameter of the object-side surface of the fourth spacing element, and d3m is the inner diameter of the image-side surface of the third spacing element. By means of controlling the optical photographic lens assembly to satisfy the conditional expression 1.35<|R7/R6|×(d4s/d3m)≤2.4, the radius of curvature of the image-side surface of the third lens and the radius of curvature of the object-side surface of the fourth lens are able to be effectively controlled to ensure that imaging light rays are refracted between the third lens and the fourth lens in a required direction, and meanwhile, the inner diameter of the image-side surface of the third spacing element and the inner diameter of the object-side surface of the fourth spacing element are controlled to effectively control and weaken the intensity of the stray light of the fourth lens and to intercept some transmission and reflection stray light paths. In an exemplary implementation, the optical photographic lens assembly of the disclosure satisfies a conditional expression 0.7<CT4/(EP34+CP4)<1.05, wherein CT4 is a center thickness of the fourth lens on the optical axis, EP34 is a distance from the image-side surface of the third spacing element to the object-side surface of the fourth spacing element on the optical axis, and CP4 is the maximum thickness of the fourth spacing element along the optical axis. The maximum thickness of the fourth spacing element is the maximum thickness of the fourth spacing element in the direction of the optical axis or the direction parallel to the optical axis. By means of controlling the optical photographic lens assembly to satisfy the conditional expression 0.7<CT4/(EP34+CP4)<1.05, the center thickness level of the fourth lens is able to be reasonably ensured, and the edge thickness of the fourth lens and the overall thickness of the fourth spacing element are able to be controlled; and the thickness ratio of the fourth lens is able to be reasonably controlled to improve the molding feasibility of the fourth lens and to reduce the risk of weld marks, and meanwhile, the structural strength of the fourth spacing element is able to be effectively ensured.

In an exemplary implementation, the optical photographic lens assembly of the disclosure satisfies a conditional expression 0.8< (EP45+CP5)/CT5<2.3, wherein EP45 is a distance from the image-side surface of the fourth spacing element to an object-side surface of the fifth spacing element on the optical axis, CP5 is a maximum thickness of the fifth spacing element along the optical axis, and CT5 is a center thickness of the fifth lens on the optical axis. The maximum thickness of the fifth spacing element is the maximum thickness of the fifth spacing element in the direction of the optical axis or the direction parallel to the optical axis. By means of controlling the optical photographic lens assembly to satisfy the conditional expression 0.8<(EP45+CP5)/CT5<2.3, the edge thickness of the fifth lens, the thickness of the fifth spacing element and the center thickness of the fifth lens are able to be directly controlled; the thickness ratio of the fifth lens is able to be reasonably controlled to improve the molding feasibility of the fifth lens and to reduce the risk of weld marks; and meanwhile, the structural strength of the fifth spacing element is able to be effectively ensured. In an embodiment, the EP45, the CP5 and the CT5 satisfy: 0.8<(EP45+CP5)/CT5<2.26. In another embodiment, the EP45, the CP5 and the CT5 satisfy: 0.84≤(EP45+CP5)/CT5≤2.24.

In an exemplary implementation, the optical photographic lens assembly of the disclosure satisfies a conditional expression 5.8<R11/|d5s−d5m|<11.6, wherein R11 is a radius of curvature of the object-side surface of the sixth lens, d5s is an inner diameter of the object-side surface of the fifth spacing element, and d5m is an inner diameter of an image-side surface of the fifth spacing element. By means of controlling the optical photographic lens assembly to satisfy the conditional expression 5.8<R11/|d5s−d5m|<11.6, a refraction path of the imaging light rays passing through the fifth lens and the sixth lens is able to be effectively controlled, and meanwhile the supporting misalignment quantity between the fifth spacing element and the sixth lens is able to be reduced, thereby facilitating to ensure the assembly stability of a large-segment-gap structure herein. In an embodiment, the R11, the d5s and the d5m satisfy: 5.83<R11/|d5s−d5m|<11.55. In another embodiment, the R11, the d5s and the d5m satisfy: 5.85≤R11/|d5s−d5m|≤11.53.

In an exemplary implementation, the optical photographic lens assembly of the disclosure satisfies a conditional expression 0.25<R12/D5m<0.6, wherein R12 is a radius of curvature of the image-side surface of the sixth lens, and D5m is an outer diameter of the image-side surface of the fifth spacing element. By means of controlling the ratio of the radius of curvature of the image-side surface of the sixth lens to the outer diameter of the image-side surface of the fifth spacing element within this range, it can be indirectly ensured that the outer diameter level of the sixth lens is within a suitable range, thereby controlling and reducing the possibility of a structural region of the sixth lens reflecting stray light; and meanwhile, by means of controlling the radius of curvature of the image-side surface of the sixth lens, optimization control is able to be performed on reflection ghost images of the image-side surface of the sixth lens and the object-side surface of the seventh lens to a certain extent.

In an exemplary implementation, the optical photographic lens assembly of the disclosure satisfies a conditional expression 4.1<T67/EP56+T67/CT7<6.3, wherein T67 is an air gap between the sixth lens and the seventh lens on the optical axis, that is, a distance from the image-side surface of the sixth lens to the object-side surface of the seventh lens on the optical axis, EP56 is a distance from the image-side surface of the fifth spacing element to an object-side surface of the sixth spacing element on the optical axis, and CT7 is a center thickness of the seventh lens on the optical axis. By means of controlling the optical photographic lens assembly to satisfy the conditional expression 4.1<T67/EP56+T67/CT7<6.3, the edge thickness of the sixth lens and the center thickness of the seventh lens are able to be effectively controlled, thereby facilitating to ensure the molding stability of the last two lenses, ensuring the stability of data such as surface type eccentricity of the lens, and helping to improve the MTF performance yield. In an embodiment, the T67, the EP56 and the CT7 satisfy: 4.1<T67/EP56+T67/CT7<6.25. In another embodiment, the T67, the EP56 and the CT7 satisfy: 4.11≤T67/EP56+T67/CT7≤6.23. In an exemplary implementation, the optical photographic lens assembly of the disclosure satisfies a conditional expression 0.33<f6/f7≤2.0, wherein f6 is an effective focal length of the sixth lens, and f7 is an effective focal length of the seventh lens. By means of controlling the ratio of the effective focal length of the sixth lens to the effective focal length of the seventh lens within this range, the effective focal length of the sixth lens and the effective focal length of the seventh lens are able to be directly controlled, so as to adjust the refraction of full-field-of-view rays on the rear end of the optical system to propagate in a required direction and finally reach a given image height, and meanwhile, the surface type sensitivity of the overall external field of view MTF is able to also be reduced to a certain extent.

In an exemplary implementation, the optical photographic lens assembly of the disclosure satisfies a conditional expression 0.45<|R13/d6m|≤0.7, wherein R13 is a radius of curvature of the object-side surface of the seventh lens, and d6m is an inner diameter of an image-side surface of the sixth spacing element. By means of controlling the optical photographic lens assembly to satisfy the conditional expression 0.45<|R13/d6m|≤0.7, the outer diameter of the seventh lens and the refraction direction of the light rays is able to be effectively ensured, thereby facilitating the control over the reflection path of the stray light at the position of the seventh lens structure, and reducing the stray light intensity of the last lens to a certain extent.

In an exemplary implementation, the optical photographic lens assembly of the disclosure satisfies a conditional expression 1.14<|R14|/(D6m−d6m)≤1.85, wherein R14 is a radius of curvature of the image-side surface of the seventh lens, Dom is an outer diameter of the image-side surface of the sixth spacing element, and d6m is the inner diameter of the image-side surface of the sixth spacing element. By means of controlling the optical photographic lens assembly to satisfy the conditional expression 1.14</R14|/(D6m−d6m)≤1.85, a supporting area of the sixth spacing element and the seventh lens is able to be ensured, thereby ensuring the stability of assembly and support between the sixth spacing element and the seventh lens, and improving the assembly stability of the overall lens; and meanwhile, the surface shape of the surface of the seventh lens facing a light-emitting side is able to be indirectly controlled, thereby improving the machinability of the seventh lens.

In an exemplary implementation, the optical photographic lens assembly of the disclosure includes at least one diaphragm. The diaphragm may constrain a light path and control the light intensity. The diaphragm is disposed at a proper position of the optical photographic lens assembly, in an embodiment, the diaphragm is disposed between the first lens and the second lens; in another embodiment, the diaphragm is disposed between the object side and the first lens; in another embodiment the diaphragm is disposed between the second lens and the third lens. In an exemplary implementation, optionally, the optical photographic lens assembly further includes an optical filter used for correcting chromatic aberration and/or protective glass used for protecting a photosensitive element located on the imaging surface.

In the optical photographic lens assembly according to an implementation of the disclosure includes the lens group and the at least one spacing element, the lens group includes the first to seventh lenses that are sequentially arranged from the object side to the image side along the optical axis, and there is the air gap between any two adjacent lenses; the first lens to the seventh lens include at least one aspheric lens; there are seven lenses having refractive powers in the optical photographic lens assembly; the at least one spacing element includes the fourth spacing element, located between the fourth lens and the fifth lens and in contact with the image-side surface of the fourth lens; the maximum thickness CP4 of the fourth spacing element along the optical axis and the air gap T45 between the fourth lens and the fifth lens on the optical axis satisfy the conditional expression 3.85<CP4/T45<19.6; the radius of curvature R8 of the image-side surface of the fourth lens and the inner diameter d4s of the object-side surface of the fourth spacing element satisfy the conditional expression −1.0<R8/d4s<−0.4; the radius of curvature R9 of the object-side surface of the fifth lens and the inner diameter d4m of the image-side surface of the fourth spacing element satisfy the conditional expression 2.15<|R9/d4m|<2.55. By means of such settings of the optical photographic lens assembly, the lens is able to achieve the technical features of high pixels and small distortion, wherein a ratio of the maximum thickness CP4 of the fourth spacing element along the optical axis to the air gap between the fourth lens and the fifth lens satisfies the foregoing conditional expression 3.85<CP4/T45<19.6, which means that the span of effective diameter edges of the fourth lens and the fifth lens is relatively large and thus a relatively thick spacing element needs to be disposed herein for spacing, however the angles of rays of an edge field of view herein is relatively steep, resulting in a certain risk of reflecting stray light on an inner-diameter inclined ring surface of the spacing element in the case of incidence of large-angle incident light rays; meanwhile, by means of controlling the satisfaction of the conditional expressions −1.0<R8/d4s<−0.4 and 2.15<|R9/d4m|<2.55, the stray light is able to be effectively controlled, thereby achieving an inhibitory effect.

The optical photographic lens assembly according to another implementation of the disclosure includes the lens group and the at least one spacing element, the lens group includes the first to seventh lenses that are sequentially arranged from the object side to the image side along the optical axis, and there is the air gap between any two adjacent lenses; the first lens to the seventh lens include at least one aspheric lens; there are seven lenses having refractive powers in the optical photographic lens assembly; the at least one spacing element includes the fourth spacing element, located between the fourth lens and the fifth lens and in contact with the image-side surface of the fourth lens, the first spacing element, located between the first lens and the second lens and in contact with the image-side surface of the first lens, and the second spacing element, located between the second lens and the third lens and in contact with the image-side surface of the second lens; and the radius of curvature R3 of the object-side surface of the second lens, the outer diameter D2s of the object-side surface of the second spacing element and the outer diameter D1m of the image-side surface of the first spacing element satisfy the conditional expression 7.3<R3/(D2s−D1m)<15.4. By means of such settings of the optical photographic lens assembly, the optical photographic lens assembly is able to achieve the technical features of high pixels and small distortion; and the imaging light raysnon-imaging light rays entering/exiting the second lens is able to be directly controlled, and inner apertures of the spacing elements in front of and behind the second lens is able to intercept transmitted stray light and internal reflected stray light of the second lens, thereby improving the glare level of the whole lens and improving the picture cleanliness.

The optical photographic lens assembly according to yet another implementation of the disclosure includes the lens group and the at least one spacing element, the lens group includes the first to seventh lenses that are sequentially arranged from the object side to the image side along the optical axis, and there is the air gap between any two adjacent lenses; the first lens to the seventh lens include at least one aspheric lens; there are seven lenses having refractive powers in the optical photographic lens assembly; the at least one spacing element includes the fourth spacing element, located between the fourth lens and the fifth lens and in contact with the image-side surface of the fourth lens, the second spacing element, located between the second lens and the third lens and in contact with the image-side surface of the second lens, and the third spacing element, located between the third lens and the fourth lens and in contact with the image-side surface of the third lens; and the effective focal length f3 of the third lens, the center thickness CT3 of the third lens on the optical axis, the maximum thickness CP2 of the second spacing element along the optical axis, and the maximum thickness CP3 of the third spacing element along the optical axis satisfies: −39.1<f3/(CT3+CP2+CP3)≤−11.0. By means of such settings of the optical photographic lens assembly, the optical photographic lens assembly is able to achieve the technical features of high pixels and small distortion; and effective control over the focal length of the third lens is able to be achieved, and meanwhile, the thickness of the second spacing element, the thickness of the third spacing element, and the center thickness of the third lens is able to be adjusted and controlled, thereby effectively ensuring that the thickness of the second spacing element and the thickness of the third spacing element are at a suitable level, enhancing the stability of the assembly, and improving the yield of an assembly manufacturing process.

The optical photographic lens assembly according to a still another implementation of the disclosure includes the lens group and the at least one spacing element, the lens group includes the first to seventh lenses that are sequentially arranged from the object side to the image side along the optical axis, and there is the air gap between any two adjacent lenses; the first lens to the seventh lens include at least one aspheric lens; there are seven lenses having refractive powers in the optical photographic lens assembly; the at least one spacing element includes the fourth spacing element, located between the fourth lens and the fifth lens and in contact with the image-side surface of the fourth lens, the fifth spacing element, located between the fifth lens and the sixth lens and in contact with the image-side surface of the fifth lens, and the sixth spacing element, located between the sixth lens and the seventh lens and in contact with the image-side surface of the sixth lens; and the air gap T67 between the sixth lens and the seventh lens on the optical axis, the distance EP56 from the image-side surface of the fifth spacing element to the object-side surface of the sixth spacing element on the optical axis, and the center thickness CT7 of the seventh lens on the optical axis satisfies: 4.1<T67/EP56+T67/CT7<6.3. By means of such settings of the optical photographic lens assembly, the optical photographic lens assembly is able to achieve the technical features of high pixels and small distortion; and the edge thickness of the sixth lens and the center thickness of the seventh lens are able to be effectively controlled, thereby facilitating to ensure the molding stability of the last two lenses, ensuring the stability of data such as surface type eccentricity of the lens, and helping to improve the MTF performance yield. However, those skilled in the art should understand that, without departing from the technical solutions claimed in the disclosure, the number of lenses constituting the optical photographic lens assembly is changed and the number of spacing elements is changed to obtain various results and advantages described in the present specification, which is not specifically limited in the disclosure. For example, although the seven lenses are taken as an example for description in the implementations, the optical photographic lens assembly is not limited to including seven lenses.

The optical photographic lens assembly may also include other numbers of lenses as needed. As another example, the optical photographic lens assembly may also include other numbers of spacing elements different from those described in the above embodiments as needed.

Specific embodiments of the optical photographic lens assembly applicable to the above implementations are further described below with reference to the drawings.

### Embodiment 1

An optical photographic lens assembly according to Embodiment 1 of the disclosure is described below with reference to FIG. 2.

As shown in FIG. 2, in this embodiment, the optical photographic lens assembly includes a lens barrel P0, and a first lens E1, a second lens E2, a third lens E3, a fourth lens E4, a fifth lens E5, a sixth lens E6, and a seventh lens E7, which are accommodated in the lens barrel P0 and are sequentially arranged from an object side to an image side along an optical axis.

In this embodiment, the optical photographic lens assembly further includes a plurality of spacing elements: a first spacing element P1, located between the first lens E1 and the second lens E2 and in direct contact with an image-side surface of the first lens E1; a second spacing element P2, located between the second lens E2 and the third lens E3 and in direct contact with an image-side surface of the second lens E2; a third spacing element P3, located between the third lens E3 and the fourth lens E4 and in direct contact with an image-side surface of the third lens E3; a fourth spacing element P4, located between the fourth lens E4 and the fifth lens E5 and in direct contact with an image-side surface of the fourth lens E4; a fifth spacing element P5, located between the fifth lens E5 and the sixth lens E6 and in direct contact with an image-side surface of the fifth lens E5; and a sixth spacing element P6, located between the sixth lens E6 and the seventh lens E7 and in direct contact with an image-side surface of the sixth lens E6.

In this embodiment, the first lens E1 has a negative refractive power, an object-side surface S1 of the first lens is a concave surface, and an image-side surface S2 of the first lens is a convex surface. The second lens E2 has a positive refractive power, an object-side surface S3 of the second lens is a convex surface, and an image-side surface S4 of the second lens is a convex surface. The third lens E3 has a negative refractive power, an object-side surface S5 of the third lens is a concave surface, and an image-side surface S6 of the third lens is a convex surface. The fourth lens E4 has a positive refractive power, an object-side surface S7 of the fourth lens is a convex surface, and an image-side surface S8 of the fourth lens is a convex surface. The fifth lens E5 has a positive refractive power, an object-side surface S9 of the fifth lens is a concave surface, and an image-side surface S10 of the fifth lens is a convex surface. The sixth lens E6 has a negative refractive power, an object-side surface S11 of the sixth lens is a convex surface, and an image-side surface S12 of the sixth lens is a concave surface. The seventh lens E7 has a negative refractive power, an object-side surface S13 of the seventh lens is a concave surface, and an image-side surface S14 of the seventh lens is a convex surface.

In this embodiment, a diaphragm STO is located between the first lens E1 and the second lens E2. In this embodiment, the optical photographic lens assembly further includes, an optical filter (not shown), which is located on the image side of the seventh lens E7 and has an object-side surface S15 and an image-side surface S16, and an imaging surface S17 (not shown) located on the image side of the optical filter. Light rays from an object sequentially pass through the surfaces S1 to S16 and are finally imaged on the imaging surface S17.

Table 1 illustrates a basic parameter table of the optical photographic lens assembly in Embodiment 1, wherein a radius of curvature and a thickness/distance are in units of millimeters (mm).

TABLE 1

| | | | | Material | | |
|---|---|---|---|---|---|---|
| Surface | | Radius of | Thickness/ | Refractive | Abbe | Conic |
| number | Surface type | curvature | distance | index | number | coefficient |
| OBJ | Spherical surface | Infinite | Infinite | | | |
| S1 | Aspheric surface | −9.0271 | 0.8859 | 1.80 | 46.6 | 0.0000 |
| S2 | Aspheric surface | −10.1993 | 0.0500 | | | |
| STO | Spherical surface | Infinite | 0.0500 | | | |
| S3 | Aspheric surface | 12.4313 | 1.1488 | 1.56 | 43.6 | 0.0000 |
| S4 | Aspheric surface | −3904.3266 | 0.4932 | | | 0.0000 |
| S5 | Aspheric surface | −2.7857 | 0.3000 | 1.66 | 20.2 | 0.0000 |
| S6 | Aspheric surface | −5.0298 | 0.0500 | | | 0.0000 |
| S7 | Aspheric surface | 9.8116 | 1.2828 | 1.54 | 56.0 | 0.0000 |
| S8 | Aspheric surface | −3.4670 | 0.3000 | | | 0.0000 |
| S9 | Aspheric surface | −14.9104 | 1.0635 | 1.54 | 56.0 | 0.0000 |
| S10 | Aspheric surface | −4.1183 | 0.0500 | | | 0.0000 |
| S11 | Aspheric surface | 7.0347 | 0.6508 | 1.65 | 21.9 | 0.0000 |
| S12 | Aspheric surface | 3.5311 | 1.6125 | | | 0.0000 |
| S13 | Aspheric surface | −3.9533 | 0.5654 | 1.62 | 26.9 | 0.0000 |
| S14 | Aspheric surface | −5.1591 | 0.7610 | | | 0.0000 |
| S15 | Spherical surface | Infinite | 0.2100 | 1.52 | 64.2 | 0.0000 |
| S16 | Spherical surface | Infinite | 0.7728 | | | |
| S17 | Spherical surface | Infinite | | | | |

In this embodiment, both the object-side surface and the image-side surface of any of the first lens E1 to the seventh lens E7 are aspheric surfaces, and the surface types of the aspheric lenses is defined by using, but not limited to, the following aspheric formula:

$$x = \frac{{ch}^{2}}{1 + \sqrt{1 - ( k + 1 ) {c}^{2} {h}^{2}}} + \sum {Aih}^{i} \qquad ( 1 )$$

wherein x is a distance vector height from the vertex of the aspheric surface when the height of the aspheric surface in the direction of the optical axis is h; c is an paraxial curvature of the aspheric surface, c=1/R (that is, the paraxial curvature c is a reciprocal of the radius of curvature R in Table 1); k is the conic coefficient; and Ai is a correction coefficient of an i-th order of the aspheric surface. Table 2-1 and Table 2-2 illustrate high-order coefficients A₄, A₆, A₈, A₁₀, A₁₂, A₁₄, A₁₆, A₁₈, A₂₀, A₂₂, A₂₄, A₂₆, A₂₈ and A₃₀ that are used for the aspheric surfaces S1-S14 in this embodiment.

TABLE 2-1

| Surface number | A4 | A6 | A8 | A10 | A12 | A14 | A16 |
|---|---|---|---|---|---|---|---|
| S1 | 6.58E−01 | −1.26E−01 | 1.34E−02 | 3.57E−03 | −3.92E−03 | 1.04E−04 | 1.60E−03 |
| S2 | 3.80E−01 | −1.03E−01 | 1.70E−02 | 4.70E−03 | −5.00E−03 | 2.64E−05 | 1.66E−03 |
| S3 | −2.71E−01 | −2.84E−04 | 1.04E−02 | 8.15E−04 | −3.23E−04 | 1.31E−03 | 6.62E−04 |
| S4 | −7.39E−01 | 6.90E−02 | −2.64E−03 | 7.67E−03 | 6.44E−03 | 1.67E−03 | −1.02E−03 |
| S5 | 7.47E−01 | 1.46E−01 | 2.03E−02 | 3.19E−02 | 1.48E−02 | 1.38E−02 | 4.58E−03 |
| S6 | 4.60E−01 | −5.19E−03 | −2.39E−02 | 2.45E−02 | −1.21E−02 | 3.76E−03 | −1.18E−03 |
| S7 | −6.95E−01 | 2.37E−01 | −6.77E−02 | −4.91E−03 | 2.20E−03 | −1.08E−03 | −2.59E−03 |
| S8 | −2.31E−01 | −7.01E−02 | 1.40E−01 | −1.05E−02 | −3.34E−02 | 9.92E−03 | 8.07E−03 |
| S9 | 2.98E−01 | 7.65E−02 | −1.58E−01 | −3.27E−02 | 3.03E−02 | 3.01E−02 | −3.21E−03 |
| S10 | −5.39E−01 | −1.39E−01 | 1.90E−01 | −4.05E−02 | −4.91E−02 | 1.15E−02 | 1.86E−02 |
| S11 | 2.63E−01 | 2.74E−01 | 2.21E−01 | −8.50E−02 | −1.60E−02 | −6.19E−02 | 3.85E−02 |
| S12 | 5.28E−01 | 1.29E−01 | 5.08E−02 | −3.77E−02 | 4.61E−02 | −7.05E−02 | 2.04E−02 |
| S13 | −7.24E−03 | 1.01E+00 | 9.23E−01 | 3.08E−01 | −9.14E−02 | 3.86E−02 | 6.88E−02 |
| S14 | 2.17E+00 | 1.86E+00 | 5.69E−01 | −4.18E−02 | 1.21E−01 | 3.46E−01 | 4.52E−02 |

TABLE 2-2

| Surface number | A18 | A20 | A22 | A24 | A26 | A28 | A30 |
|---|---|---|---|---|---|---|---|
| S1 | −4.76E−04 | −4.32E−04 | 5.43E−04 | 7.61E−05 | −3.00E−04 | −1.97E−05 | 9.49E−05 |
| S2 | −2.61E−04 | −3.24E−04 | 2.52E−04 | 1.30E−04 | −7.66E−05 | −1.61E−05 | −2.47E−05 |
| S3 | −6.41E−04 | −4.87E−04 | 1.61E−04 | 3.51E−04 | 4.17E−05 | −1.00E−04 | −5.70E−05 |
| S4 | −3.39E−04 | 4.84E−04 | 2.97E−04 | −1.04E−04 | −1.38E−04 | −1.32E−06 | 2.33E−05 |
| S5 | 3.40E−03 | 2.02E−03 | 1.43E−03 | −3.55E−04 | 1.75E−04 | 6.43E−04 | 2.20E−04 |
| S6 | 1.20E−03 | −1.92E−03 | 2.59E−03 | −1.60E−03 | −3.40E−04 | 2.78E−04 | 2.11E−04 |
| S7 | 4.02E−03 | −1.57E−03 | −4.08E−04 | −4.24E−04 | 1.52E−04 | 1.24E−04 | 1.75E−04 |
| S8 | −7.60E−04 | −9.62E−03 | −4.11E−03 | 6.25E−03 | −4.76E−04 | −1.01E−03 | −2.17E−03 |
| S9 | −9.87E−03 | −4.07E−03 | 1.52E−03 | −1.46E−03 | −2.27E−03 | 2.98E−03 | −3.88E−03 |
| S10 | −1.94E−02 | −7.67E−03 | 1.60E−02 | −4.10E−03 | −7.90E−03 | 5.48E−03 | −1.44E−03 |
| S11 | 1.18E−02 | −3.72E−02 | −2.85E−02 | 1.01E−02 | 2.34E−02 | 9.54E−03 | −1.20E−02 |
| S12 | 2.48E−02 | −2.08E−02 | −8.39E−03 | 2.78E−02 | 1.41E−03 | −1.49E−02 | 6.63E−03 |
| S13 | 3.05E−02 | −2.02E−02 | −3.10E−02 | −1.32E−02 | 3.49E−02 | −3.64E−02 | 1.47E−02 |
| S14 | −1.24E−01 | 6.12E−02 | 9.23E−02 | −7.72E−02 | −4.14E−02 | 6.71E−02 | −3.60E−02 |

Referring to Table 7, the numerical values of a plurality of related parameters regarding the lens barrel and the spacing elements in this embodiment are respectively shown in the ‘Embodiment 1’ column of Table 7, and specific descriptions of the plurality of related parameters shown in Table 7 are as follows:

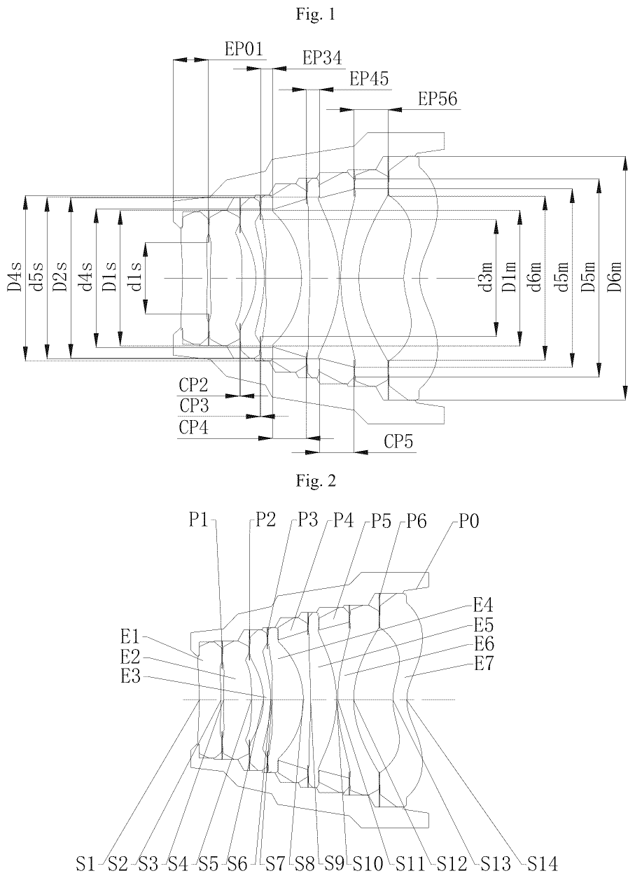

d1s is an inner diameter of an object-side surface of the first spacing element P1, D1s is an outer diameter of the object-side surface of the first spacing element P1, D1m is an outer diameter of an image-side surface of the first spacing element P1, D2s is an outer diameter of an object-side surface of the second spacing element P2, d3m is an inner diameter of an image-side surface of the third spacing element P3, d4s is an inner diameter of an object-side surface of the fourth spacing element P4, D4s is an outer diameter of the object-side surface of the fourth spacing element P4, d5s is an inner diameter of an object-side surface of the fifth spacing element P5, d5m is an inner diameter of an image-side surface of the fifth spacing element P5, D5m is an outer diameter of the image-side surface of the fifth spacing element P5, d6m is an inner diameter of an image-side surface of the sixth spacing element P6, Dom is an outer diameter of the image-side surface of the sixth spacing element P6, CP2 is a maximum thickness of the second spacing element P2 along the optical axis, CP3 is a maximum thickness of the third spacing element along the optical axis P3 in the direction of the optical axis, CP4 is a maximum thickness of the fourth spacing element P4 along the optical axis, CP5 is a maximum thickness of the fifth spacing element P5 along the optical axis, EP01 is a distance from an object-side end surface of the lens barrel to the object-side surface of the first spacing element P1 on the optical axis, EP34 is a distance from the image-side surface of the third spacing element P3 to the object-side surface of the fourth spacing element P4 on the optical axis, EP45 is a distance from the image-side surface of the fourth spacing element P4 to the object-side surface of the fifth spacing element P5 on the optical axis, and EP56 is a distance from the image-side surface of the fifth spacing element P5 to the object-side surface of the sixth spacing element P6 on the optical axis. The numerical values of the above parameters shown in Table 7 are all in units of millimeters (mm), and the schematic diagrams of the above parameters in the structural diagram of the optical photographic lens assembly are as shown in FIG. 1.

### Embodiment 2

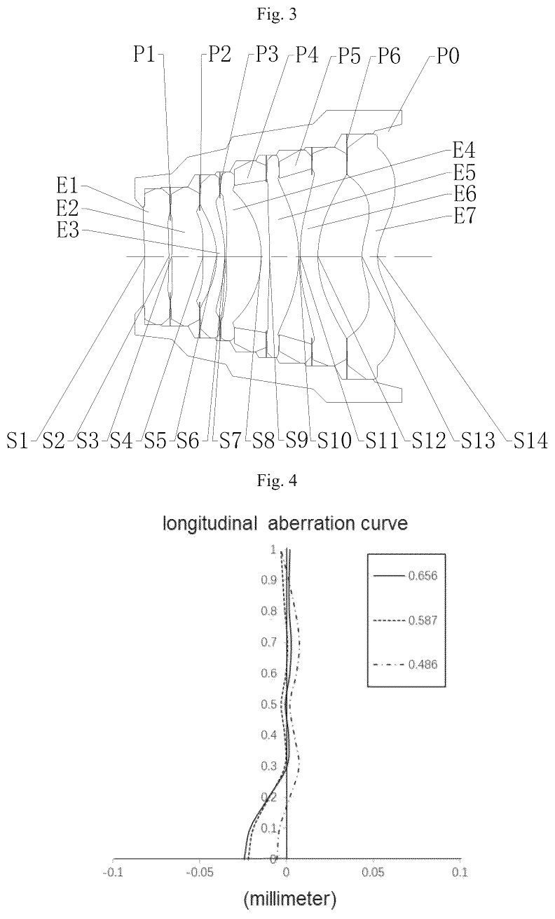

An optical photographic lens assembly according to Embodiment 2 of the disclosure is described below with reference to FIG. 3.

As shown in FIG. 3, in this embodiment, similar to Embodiment 1, the optical photographic lens assembly also includes a lens barrel P0, and a first lens E1, a second lens E2, a third lens E3, a fourth lens E4, a fifth lens E5, a sixth lens E6, and a seventh lens E7, which are accommodated in the lens barrel P0 and are sequentially arranged from an object side to an image side along an optical axis. The optical photographic lens assembly further includes a plurality of spacing elements: a first spacing element P1, located between the first lens E1 and the second lens E2 and in direct contact with an image-side surface of the first lens E1; a second spacing element P2, located between the second lens E2 and the third lens E3 and in direct contact with an image-side surface of the second lens E2; a third spacing element P3, located between the third lens E3 and the fourth lens E4 and in direct contact with an image-side surface of the third lens E3; a fourth spacing element P4, located between the fourth lens E4 and the fifth lens E5 and in direct contact with an image-side surface of the fourth lens E4; a fifth spacing element P5, located between the fifth lens E5 and the sixth lens E6 and in direct contact with an image-side surface of the fifth lens E5; and a sixth spacing element P6, located between the sixth lens E6 and the seventh lens E7 and in direct contact with an image-side surface of the sixth lens E6.

Moreover, the basic parameter table of the optical photographic lens assembly in this embodiment is the same as Table 1 in Embodiment 1, and high-order coefficient tables of aspheric surfaces are the same as Table 2-1 and Table 2-2 in Embodiment 1.

The numerical values of related parameters of the optical photographic lens assembly in this embodiment are shown in the ‘Embodiment 2’ column of Table 7, wherein specific descriptions of meanings represented by the parameters are the same as the descriptions in Embodiment 1, and thus details are not repeated herein again.

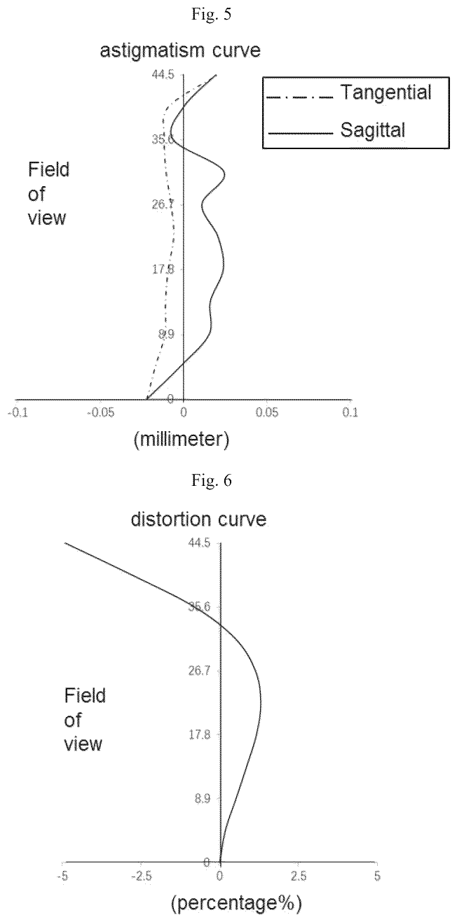

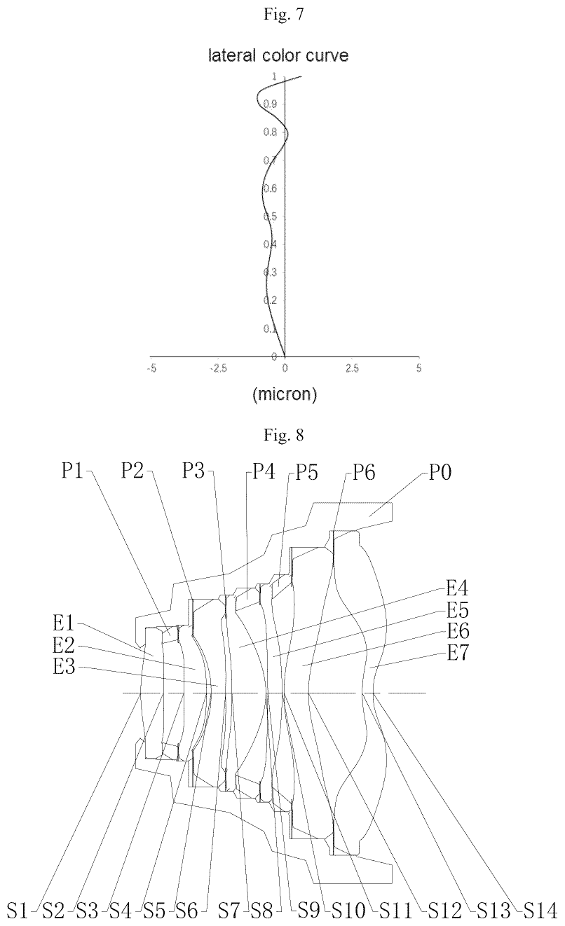

FIG. 4 illustrates longitudinal aberration curves of the optical photographic lens assemblies in Embodiment 1 and Embodiment 2, which represent deviations of focal points of rays of different wavelengths after passing through the optical photographic lens assembly. FIG. 5 illustrates astigmatism curves of the optical photographic lens assemblies in Embodiment 1 and Embodiment 2, which represent tangential image surface bending and sagittal image surface bending. FIG. 6 illustrates a distortion curve of the optical photographic lens assemblies in Embodiment 1 and Embodiment 2, which represents distortion values corresponding to different angles of field of view. FIG. 7 illustrates a lateral color curve of the optical imaging lenses in Embodiment 1 and Embodiment 2, which represents deviations of different image heights on the imaging surface after the light rays pass through the optical photographic lens assembly. It can be seen from FIGS. 4 to 7 that the optical photographic lens assemblies provided in Embodiment 1 and Embodiment 2 may achieve good imaging quality.

### Embodiment 3

An optical photographic lens assembly according to Embodiment 3 of the disclosure is described below with reference to FIG. 8.

As shown in FIG. 8, in this embodiment, the optical photographic lens assembly includes a lens barrel P0, and a first lens E1, a second lens E2, a third lens E3, a fourth lens E4, a fifth lens E5, a sixth lens E6, and a seventh lens E7, which are accommodated in the lens barrel P0 and are sequentially arranged from an object side to an image side along an optical axis.

In this embodiment, the optical photographic lens assembly further includes a plurality of spacing elements: a first spacing element P1, located between the first lens E1 and the second lens E2 and is in direct contact with an image-side surface of the first lens E1; a second spacing element P2, located between the second lens E2 and the third lens E3 and in direct contact with an image-side surface of the second lens E2; a third spacing element P3, located between the third lens E3 and the fourth lens E4 and in direct contact with an image-side surface of the third lens E3; a fourth spacing element P4, located between the fourth lens E4 and the fifth lens E5 and in direct contact with an image-side surface of the fourth lens E4; a fifth spacing element P5, located between the fifth lens E5 and the sixth lens E6 and in direct contact with an image-side surface of the fifth lens E5; and a sixth spacing element P6, located between the sixth lens E6 and the seventh lens E7 and in direct contact with an image-side surface of the sixth lens E6.

In this embodiment, the first lens E1 has a positive refractive power, an object-side surface S1 of the first lens is a convex surface, and an image-side surface S2 of the first lens is a concave surface. The second lens E2 has a positive refractive power, an object-side surface S3 of the second lens is a convex surface, and an image-side surface S4 of the second lens is a convex surface. The third lens E3 has a negative refractive power, an object-side surface S5 of the third lens is a concave surface, and an image-side surface S6 of the third lens is a concave surface. The fourth lens E4 has a positive refractive power, an object-side surface S7 of the fourth lens is a concave surface, and an image-side surface S8 of the fourth lens is a convex surface. The fifth lens E5 has a positive refractive power, an object-side surface S9 of the fifth lens is a concave surface, and an image-side surface S10 of the fifth lens is a convex surface. The sixth lens E6 has a negative refractive power, an object-side surface S11 of the sixth lens is a convex surface, and an image-side surface S12 of the sixth lens is a concave surface. The seventh lens E7 has a negative refractive power, an object-side surface S13 of the seventh lens is a convex surface, and an image-side surface S14 of the seventh lens is a concave surface.

In this embodiment, a diaphragm STO is located between the object side and the first lens E1. In this embodiment, the optical photographic lens assembly further includes, an optical filter (not shown), which is located on the image side of the seventh lens E7 and has an object-side surface S15 and an image-side surface S16, and an imaging surface S17 (not shown) located on the image side of the optical filter. Light rays from an object sequentially pass through the surfaces S1 to S16 and are finally imaged on the imaging surface S17.

Table 3 illustrates a basic parameter table of the optical photographic lens assembly in Embodiment 3, wherein a radius of curvature and a thickness/distance are in units of millimeters (mm).

TABLE 3

| | | | | Material | | |
|---|---|---|---|---|---|---|
| Surface | | Radius of | Thickness/ | Refractive | Abbe | Conic |
| number | Surface type | curvature | distance | index | number | coefficient |
| OBJ | Spherical surface | Infinite | Infinite | | | |
| STO | Spherical surface | Infinite | 0.0157 | | | |
| S1 | Aspheric surface | 6.2333 | 0.8343 | 1.71 | 54.7 | 0.0000 |
| S2 | Aspheric surface | 16.7359 | 0.7500 | | | 0.0000 |
| S3 | Aspheric surface | 17.0816 | 0.8369 | 1.55 | 52.1 | −3.1951 |
| S4 | Aspheric surface | −10.3312 | 0.1701 | | | 1.3498 |
| S5 | Aspheric surface | −5.0289 | 0.5314 | 1.62 | 23.9 | −0.2310 |
| S6 | Aspheric surface | 19.8818 | 0.2303 | | | 3.0965 |
| S7 | Aspheric surface | −24.5426 | 1.2527 | 1.54 | 56.0 | −1.0000 |
| S8 | Aspheric surface | −2.6618 | 0.0700 | | | −1.0000 |
| S9 | Aspheric surface | −14.8990 | 0.5259 | 1.59 | 31.4 | −1.0000 |
| S10 | Aspheric surface | −12.5493 | 0.0700 | | | −5.8903 |
| S11 | Aspheric surface | 6.9028 | 0.8972 | 1.55 | 51.0 | −59.7506 |
| S12 | Aspheric surface | 4.7111 | 1.9777 | | | −1.4739 |
| S13 | Aspheric surface | 5.1160 | 0.3984 | 1.57 | 38.6 | −9.7989 |
| S14 | Aspheric surface | 3.1714 | 0.5550 | | | −1.0000 |
| S15 | Spherical surface | Infinite | 0.2100 | 1.52 | 64.2 | |
| S16 | Spherical surface | Infinite | 0.9200 | | | |
| S17 | Spherical surface | Infinite | | | | |

In this embodiment, both the object-side surface and the image-side surface of any of the first lens E1 to the seventh lens E7 are aspheric surfaces, and the surface types of the aspheric lenses are defined by using the formula (1) given in Embodiment 1, and Table 4-1 and Table 4-2 illustrate high-order coefficients A₄, A₆, As, A₁₀, A₁₂, A₁₄, A₁₆, A₁₈, A₂₀, A₂₂, A₂₄, A₂₆, A₂₈ and A₃₀ and A30 that are used for the aspheric surfaces S1-S14 in this embodiment.

TABLE 4-1

| Surface number | A4 | A6 | A8 | A10 | A12 | A14 | A16 |
|---|---|---|---|---|---|---|---|
| S1 | −5.76E−02 | −4.68E−03 | −4.56E−04 | −3.38E−05 | 6.12E−07 | 3.21E−06 | 1.69E−06 |
| S2 | −1.16E−01 | −4.57E−03 | −4.23E−05 | 4.17E−05 | −7.02E−06 | 6.14E−06 | −2.21E−06 |
| S3 | −2.56E−01 | −2.67E−03 | 5.21E−03 | 7.86E−04 | −1.36E−04 | −3.41E−05 | 1.38E−05 |
| S4 | −3.44E−01 | 2.56E−02 | 4.36E−03 | 9.37E−04 | −1.12E−03 | 1.85E−04 | 2.85E−04 |
| S5 | −2.25E−01 | 3.85E−02 | −1.25E−02 | 4.09E−03 | −1.73E−03 | 6.95E−04 | 5.78E−05 |
| S6 | −4.18E−01 | 8.77E−02 | −1.80E−02 | 8.84E−03 | −4.14E−03 | 2.67E−03 | −1.42E−03 |
| S7 | −7.80E−02 | 7.45E−02 | −1.23E−02 | −8.10E−04 | −4.38E−04 | 2.57E−03 | −2.39E−03 |
| S8 | 6.26E−01 | −1.29E−01 | 2.90E−02 | −1.41E−02 | 8.12E−03 | −2.31E−03 | 8.12E−04 |
| S9 | 2.08E−01 | −1.32E−01 | 2.61E−02 | −1.58E−02 | 7.91E−03 | −4.23E−03 | 9.40E−04 |
| S10 | −6.27E−03 | 5.13E−02 | 1.80E−02 | −1.12E−02 | 1.43E−04 | 6.09E−04 | −2.25E−04 |
| S11 | 2.52E−02 | −1.67E−01 | 8.65E−02 | −4.40E−02 | 2.06E−02 | −5.50E−03 | 5.98E−04 |
| S12 | −1.37E+00 | 2.67E−01 | −5.08E−02 | −1.54E−02 | 1.60E−02 | −4.71E−03 | −3.57E−03 |
| S13 | −2.98E+00 | 1.08E+00 | −1.82E−01 | −9.13E−02 | 7.28E−02 | −3.92E−02 | 2.82E−02 |
| S14 | −5.84E+00 | 1.02E+00 | −2.20E−01 | −4.42E−02 | 5.46E−02 | −5.91E−02 | 4.23E−02 |

TABLE 4-2

| Surface number | A18 | A20 | A22 | A24 | A26 | A28 | A30 |
|---|---|---|---|---|---|---|---|
| S1 | 0.00E+00 | 0.00E+00 | 0.00E+00 | 0.00E+00 | 0.00E+00 | 0.00E+00 | 0.00E+00 |
| S2 | 0.00E+00 | 0.00E+00 | 0.00E+00 | 0.00E+00 | 0.00E+00 | 0.00E+00 | 0.00E+00 |
| S3 | 1.21E−05 | −1.87E−05 | 6.42E−07 | 3.19E−07 | 3.73E−06 | −3.06E−06 | 8.00E−07 |
| S4 | 1.33E−05 | −2.11E−04 | −3.06E−05 | 5.92E−05 | 1.92E−05 | −9.37E−06 | −4.32E−06 |
| S5 | 7.59E−05 | −2.41E−04 | 3.48E−06 | 6.68E−05 | 1.42E−05 | −1.85E−05 | −2.65E−06 |
| S6 | 3.69E−04 | −1.72E−05 | 1.34E−04 | −8.89E−06 | −5.21E−05 | 7.89E−06 | 2.28E−06 |
| S7 | 5.32E−04 | 4.30E−04 | −6.21E−05 | −3.32E−05 | −6.13E−05 | 5.86E−05 | −1.08E−05 |
| S8 | −1.32E−03 | 2.44E−04 | 8.58E−05 | 1.96E−04 | −8.32E−05 | 6.06E−05 | −1.16E−05 |
| S9 | −1.46E−04 | −2.90E−04 | 5.41E−04 | −1.38E−04 | −2.81E−04 | −5.50E−05 | −1.94E−05 |
| S10 | 3.41E−04 | −1.62E−04 | 1.84E−04 | 1.01E−04 | −3.52E−04 | 5.85E−05 | 1.84E−04 |
| S11 | −4.15E−03 | 2.72E−03 | −2.12E−03 | 1.22E−03 | −9.00E−04 | 6.76E−04 | −4.13E−05 |
| S12 | −1.17E−03 | 2.98E−03 | −2.63E−03 | 1.48E−03 | −9.92E−04 | 1.15E−03 | −5.98E−04 |
| S13 | −2.65E−02 | 1.44E−02 | −8.45E−03 | 3.51E−03 | −6.79E−04 | −2.05E−03 | 1.13E−03 |
| S14 | −3.80E−02 | 2.66E−02 | −2.09E−02 | 1.14E−02 | −4.93E−03 | 2.40E−03 | −9.69E−04 |

Referring to Table 7, the numerical values of related parameters of the optical photographic lens assembly in this embodiment are shown in the ‘Embodiment 3’ column of Table 7, wherein specific descriptions of meanings represented by the parameters are the same as the descriptions in Embodiment 1, and thus details are not repeated herein again.

### Embodiment 4

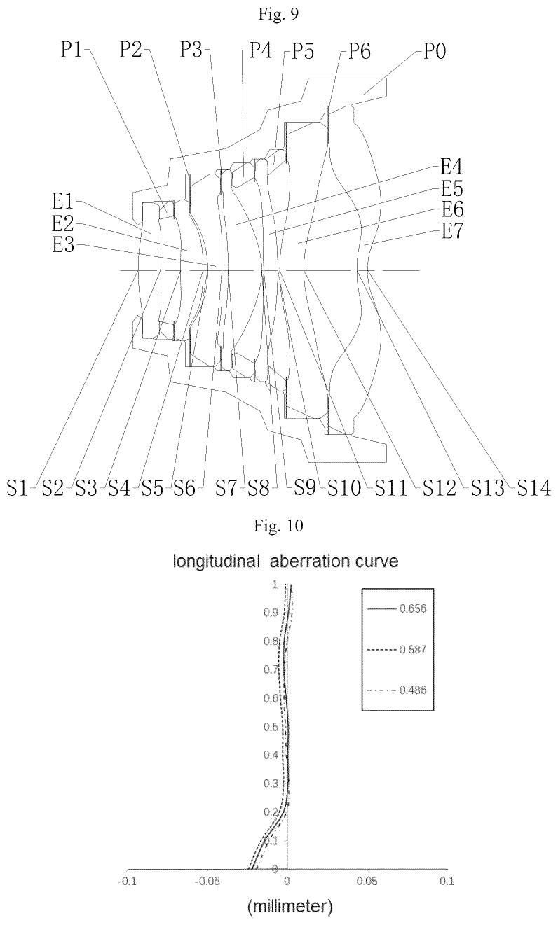

An optical photographic lens assembly according to Embodiment 4 of the disclosure is described below with reference to FIG. 9.

As shown in FIG. 9, in this embodiment, similar to Embodiment 3, the optical photographic lens assembly also includes a lens barrel P0, and a first lens E1, a second lens E2, a third lens E3, a fourth lens E4, a fifth lens E5, a sixth lens E6, and a seventh lens E7, which are accommodated in the lens barrel P0 and are sequentially arranged from an object side to an image side along an optical axis. The optical photographic lens assembly further includes a plurality of spacing elements: a first spacing element P1, located between the first lens E1 and the second lens E2 and in direct contact with an image-side surface of the first lens E1; a second spacing element P2, located between the second lens E2 and the third lens E3 and in direct contact with an image-side surface of the second lens E2; a third spacing element P3, located between the third lens E3 and the fourth lens E4 and in direct contact with an image-side surface of the third lens E3; a fourth spacing element P4, located between the fourth lens E4 and the fifth lens E5 and in direct contact with an image-side surface of the fourth lens E4; a fifth spacing element P5, located between the fifth lens E5 and the sixth lens E6 and in direct contact with an image-side surface of the fifth lens E5; and a sixth spacing element P6, located between the sixth lens E6 and the seventh lens E7 and in direct contact with an image-side surface of the sixth lens E6.

Moreover, the basic parameter table of the optical photographic lens assembly in this embodiment is the same as Table 3 in Embodiment 3, and high-order coefficient tables of aspheric surfaces are the same as Table 4-1 and Table 4-2 in Embodiment 3.

The numerical values of related parameters of the optical photographic lens assembly in this embodiment are shown in the ‘Embodiment 4’ column of Table 7, wherein specific descriptions of meanings represented by the parameters are the same as the descriptions in Embodiment 1, and thus details are not repeated herein again.

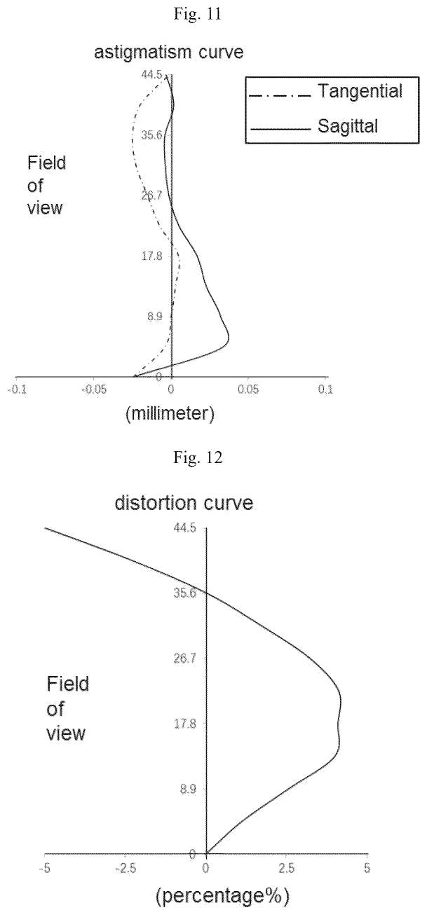

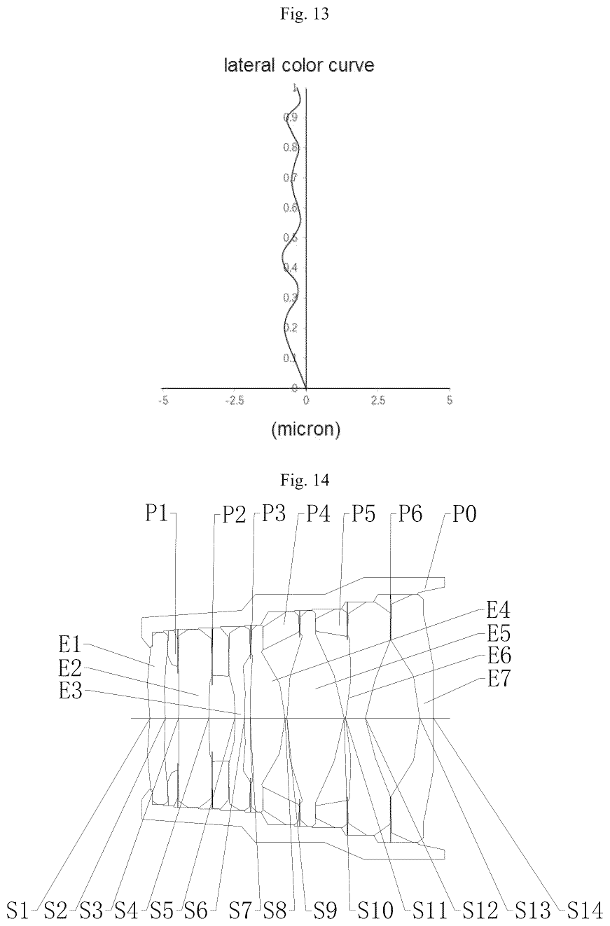

FIG. 10 illustrates longitudinal aberration curves of the optical photographic lens assemblies in Embodiment 3 and Embodiment 4, which represent deviations of focal points of rays of different wavelengths after passing through the optical photographic lens assembly. FIG. 11 illustrates astigmatism curves of the optical photographic lens assemblies in Embodiment 3 and Embodiment 4, which represent tangential image surface bending and sagittal image surface bending. FIG. 12 illustrates a distortion curve of the optical photographic lens assemblies in Embodiment 3 and Embodiment 4, which represents distortion values corresponding to different angles of field of view. FIG. 13 illustrates a lateral color curve of the optical imaging lenses in Embodiment 3 and Embodiment 4, which represents deviations of different image heights on the imaging surface after the light rays pass through the optical photographic lens assembly. It can be seen from FIGS. 10 to 13 that the optical photographic lens assemblies provided in Embodiment 3 and Embodiment 4 may achieve good imaging quality.

### Embodiment 5

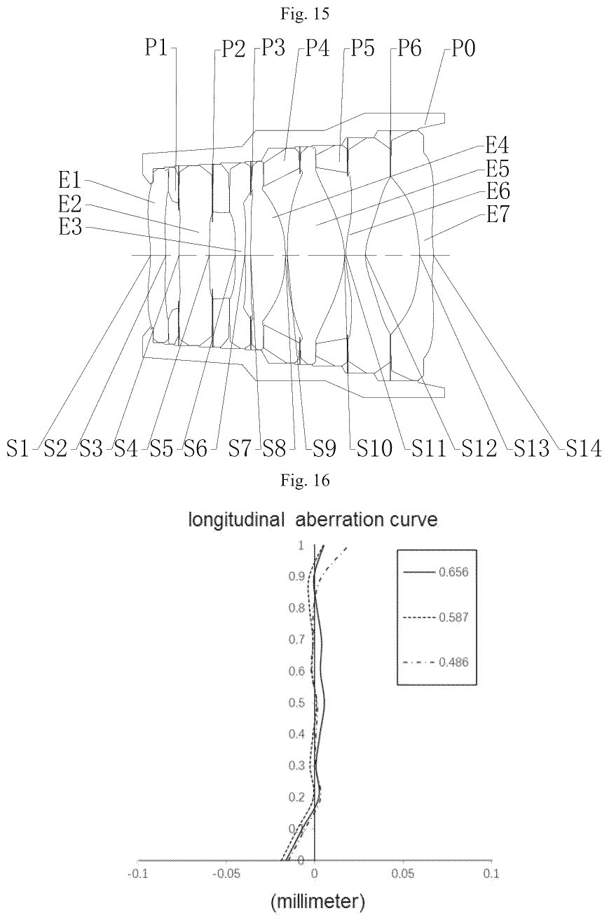

An optical photographic lens assembly according to Embodiment 5 of the disclosure is described below with reference to FIG. 15.

As shown in FIG. 14, in this embodiment, the optical photographic lens assembly includes a lens barrel P0, and a first lens E1, a second lens E2, a third lens E3, a fourth lens E4, a fifth lens E5, a sixth lens E6, and a seventh lens E7, which are accommodated in the lens barrel P0 and are sequentially arranged from an object side to an image side along an optical axis.

In this embodiment, the optical photographic lens assembly further includes a plurality of spacing elements: a first spacing element P1, located between the first lens E1 and the second lens E2 and is in direct contact with an image-side surface of the first lens E1; a second spacing element P2, located between the second lens E2 and the third lens E3 and in direct contact with an image-side surface of the second lens E2; a third spacing element P3, located between the third lens E3 and the fourth lens E4 and in direct contact with an image-side surface of the third lens E3; a fourth spacing element P4, located between the fourth lens E4 and the fifth lens E5 and in direct contact with an image-side surface of the fourth lens E4; a fifth spacing element P5, located between the fifth lens E5 and the sixth lens E6 and in direct contact with an image-side surface of the fifth lens E5; and a sixth spacing element P6, located between the sixth lens E6 and the seventh lens E7 and in direct contact with an image-side surface of the sixth lens E6.

In this embodiment, the first lens E1 has a negative refractive power, an object-side surface S1 of the first lens is a concave surface, and an image-side surface S2 of the first lens is a convex surface. The second lens E2 has a negative refractive power, an object-side surface S3 of the second lens is a convex surface, and an image-side surface S4 of the second lens is a concave surface. The third lens E3 has a negative refractive power, an object-side surface S5 of the third lens is a concave surface, and an image-side surface S6 of the third lens is a concave surface. The fourth lens E4 has a positive refractive power, an object-side surface S7 of the fourth lens is a convex surface, and an image-side surface S8 of the fourth lens is a convex surface. The fifth lens E5 has a positive refractive power, an object-side surface S9 of the fifth lens is a convex surface, and an image-side surface S10 of the fifth lens is a convex surface. The sixth lens E6 has a negative refractive power, an object-side surface S11 of the sixth lens is a convex surface, and an image-side surface S12 of the sixth lens is a concave surface. The seventh lens E7 has a negative refractive power, an object-side surface S13 of the seventh lens is a concave surface, and an image-side surface S14 of the seventh lens is a convex surface.

In this embodiment, a diaphragm STO is located between the second lens E2 and the third lens E3. In this embodiment, the optical photographic lens assembly further includes, an optical filter (not shown), which is located on the image side of the seventh lens E7 and has an object-side surface S15 and an image-side surface S16, and an imaging surface S17 (not shown) located on the image side of the optical filter. Light rays from an object sequentially pass through the surfaces S1 to S16 and are finally imaged on the imaging surface S17.

Table 5 illustrates a basic parameter table of the optical photographic lens assembly in Embodiment 5, wherein a radius of curvature and a thickness/distance are in units of millimeters (mm).

TABLE 5

| | | | | Material | | |
|---|---|---|---|---|---|---|
| Surface | | Radius of | Thickness/ | Refractive | Abbe | Conic |
| number | Surface type | curvature | distance | index | number | coefficient |
| OBJ | Spherical surface | Infinite | Infinite | | | |
| S1 | Aspheric surface | −4.0601 | 0.5380 | 1.56 | 64.1 | 0.0000 |
| S2 | Aspheric surface | −5.7409 | 0.4606 | | | 0.0000 |
| S3 | Aspheric surface | 11.8193 | 1.0564 | 1.67 | 19.2 | 0.0000 |
| S4 | Aspheric surface | 11.0103 | 0.1166 | | | 0.0000 |
| STO | Spherical surface | Infinite | 0.7941 | | | |
| S5 | Aspheric surface | −264.8439 | 0.3434 | 1.67 | 19.5 | 0.0000 |
| S6 | Aspheric surface | 10.5154 | 0.1981 | | | 0.0000 |
| S7 | Aspheric surface | 15.0552 | 1.2146 | 1.54 | 56.0 | 0.0000 |
| S8 | Aspheric surface | −4.6455 | 0.0662 | | | 0.0000 |
| S9 | Aspheric surface | 14.2635 | 2.0000 | 1.54 | 56.0 | 0.0000 |
| S10 | Aspheric surface | −2.4087 | 0.0500 | | | −1.0000 |
| S11 | Aspheric surface | 3.1304 | 0.6898 | 1.67 | 19.2 | −1.0000 |
| S12 | Aspheric surface | 1.7142 | 1.9011 | | | −1.0000 |
| S13 | Aspheric surface | −2.6018 | 0.4760 | 1.57 | 39.18 | −1.0000 |
| S14 | Aspheric surface | −4.4099 | 0.0977 | | | 0.0000 |
| S15 | Spherical surface | Infinite | 0.2100 | 1.52 | 64.2 | |
| S16 | Spherical surface | Infinite | 0.8252 | | | |
| S17 | Spherical surface | Infinite | | | | |

In this embodiment, both the object-side surface and the image-side surface of any of the first lens E1 to the seventh lens E7 are aspheric surfaces, and the surface types of the aspheric lenses are defined by using the formula (1) given in Embodiment 1, and Table 6-1 and Table 6-2 illustrate high-order coefficients A₄, A₆, As, A₁₀, A₁₂, A₁₄, A₁₆, A₁₈, A₂₀, A₂₂, A₂₄, A₂₆, A₂₈ and A₃₀ and A30 that are used for the aspheric surfaces S1-S14 in this embodiment.

TABLE 6-1

| Surface number | A4 | A6 | A8 | A10 | A12 | A14 | A 16 |
|---|---|---|---|---|---|---|---|
| S1 | 1.10E+00 | −1.40E−01 | 2.90E−02 | −1.03E−02 | 1.24E−03 | −5.50E−04 | 3.74E−04 |
| S2 | 5.61E−01 | −1.07E−01 | 2.02E−02 | −4.86E−03 | 8.53E−04 | 1.04E−04 | 3.35E−04 |
| S3 | −1.25E−01 | −3.62E−03 | 9.52E−03 | 3.27E−04 | −5.22E−04 | −1.02E−03 | −4.19E−04 |
| S4 | −7.17E−02 | 1.70E−02 | 4.39E−04 | −3.72E−03 | 5.47E−04 | 1.57E−03 | 2.70E−05 |
| S5 | −3.98E−01 | 3.21E−02 | 1.85E−02 | −2.36E−03 | −2.42E−03 | −4.63E−04 | 5.61E−04 |
| S6 | −7.78E−01 | 1.65E−01 | −3.05E−02 | 2.84E−03 | 4.49E−03 | 3.09E−04 | 2.00E−04 |
| S7 | −1.80E−01 | 6.08E−02 | −5.16E−02 | 3.19E−02 | −1.40E−02 | 4.85E−03 | −1.12E−03 |
| S8 | −6.64E−01 | 2.49E−01 | −4.08E−02 | −5.22E−03 | −1.38E−02 | 6.09E−03 | 2.38E−03 |
| S9 | 9.12E−01 | −3.54E−01 | 1.69E−01 | −4.01E−02 | 8.18E−04 | 1.19E−03 | 5.43E−03 |
| S10 | 6.35E+00 | −1.10E+00 | 2.43E−01 | −5.83E−02 | 2.84E−02 | −3.71E−02 | 3.01E−02 |
| S11 | −6.16E+00 | 1.55E+00 | −4.87E−01 | 1.71E−01 | −6.85E−02 | 2.52E−02 | −7.05E−03 |
| S12 | −5.68E+00 | 1.22E+00 | −4.89E−01 | 2.81E−01 | −1.47E−01 | 4.22E−02 | 6.75E−03 |
| S13 | 9.31E−01 | −2.10E−01 | 2.17E−01 | −1.38E−01 | 3.58E−02 | −2.69E−02 | 1.54E−02 |
| S14 | 0.00E+00 | 0.00E+00 | 0.00E+00 | 0.00E+00 | 0.00E+00 | 0.00E+00 | 0.00E+00 |

TABLE 6-2

| Surface number | A18 | A20 | A22 | A24 | A26 | A28 | A30 |
|---|---|---|---|---|---|---|---|
| S1 | 0.00E+00 | 0.00E+00 | 0.00E+00 | 0.00E+00 | 0.00E+00 | 0.00E+00 | 0.00E+00 |
| S2 | 0.00E+00 | 0.00E+00 | 0.00E+00 | 0.00E+00 | 0.00E+00 | 0.00E+00 | 0.00E+00 |
| S3 | 9.03E−05 | 3.62E−04 | 2.28E−04 | 2.79E−05 | −9.09E−05 | −7.57E−05 | −3.49E−05 |
| S4 | −1.10E−03 | −3.47E−04 | 5.30E−04 | 5.37E−04 | 8.74E−06 | −2.00E−04 | −1.18E−04 |
| S5 | 3.46E−04 | 1.35E−05 | −1.71E−04 | −3.60E−05 | 3.91E−05 | 2.70E−05 | 6.39E−06 |
| S6 | −4.89E−04 | −1.99E−04 | −3.81E−04 | 1.73E−04 | 2.22E−05 | 6.06E−05 | −7.43E−05 |
| S7 | −3.11E−04 | 1.20E−03 | −9.93E−04 | 4.49E−05 | −9.10E−05 | 1.05E−04 | 3.79E−05 |
| S8 | −5.18E−03 | 3.25E−03 | 9.29E−04 | −2.82E−03 | −9.82E−04 | 6.44E−04 | 3.57E−04 |
| S9 | −4.00E−03 | 3.03E−03 | −1.27E−03 | −3.34E−04 | −6.36E−04 | 4.70E−04 | 1.94E−04 |
| S10 | −1.66E−02 | 8.10E−03 | −4.32E−03 | 3.99E−03 | −2.32E−04 | −2.62E−03 | 1.12E−03 |
| S11 | 4.94E−04 | 3.35E−03 | −5.63E−03 | 5.00E−03 | −1.21E−03 | −2.98E−03 | 1.94E−03 |
| S12 | −1.30E−02 | −6.20E−04 | 1.11E−02 | −5.92E−03 | −7.34E−03 | 9.53E−04 | 3.30E−03 |
| S13 | −4.07E−03 | 1.98E−04 | −2.20E−04 | −2.19E−03 | −3.98E−04 | 1.76E−03 | 8.87E−04 |
| S14 | 0.00E+00 | 0.00E+00 | 0.00E+00 | 0.00E+00 | 0.00E+00 | 0.00E+00 | 0.00E+00 |

Referring to Table 7, the numerical values of related parameters of the optical photographic lens assembly in this embodiment are shown in the ‘Embodiment 5’ column of Table 7, wherein specific descriptions of meanings represented by the parameters are the same as the descriptions in Embodiment 1, and thus details are not repeated herein again.

### Embodiment 6

An optical photographic lens assembly according to Embodiment 6 of the disclosure is described below with reference to FIG. 15.

As shown in FIG. 15, in this embodiment, similar to Embodiment 5, the optical photographic lens assembly also includes a lens barrel P0, and a first lens E1, a second lens E2, a third lens E3, a fourth lens E4, a fifth lens E5, a sixth lens E6, and a seventh lens E7, which are accommodated in the lens barrel P0 and are sequentially arranged from an object side to an image side along an optical axis. The optical photographic lens assembly further includes a plurality of spacing elements: a first spacing element P1, located between the first lens E1 and the second lens E2 and in direct contact with an image-side surface of the first lens E1; a second spacing element P2, located between the second lens E2 and the third lens E3 and in direct contact with an image-side surface of the second lens E2; a third spacing element P3, located between the third lens E3 and the fourth lens E4 and in direct contact with an image-side surface of the third lens E3; a fourth spacing element P4, located between the fourth lens E4 and the fifth lens E5 and in direct contact with an image-side surface of the fourth lens E4; a fifth spacing element P5, located between the fifth lens E5 and the sixth lens E6 and in direct contact with an image-side surface of the fifth lens E5; and a sixth spacing element P6, located between the sixth lens E6 and the seventh lens E7 and in direct contact with an image-side surface of the sixth lens E6.

Moreover, the basic parameter table of the optical photographic lens assembly in this embodiment is the same as Table 5 in Embodiment 5, and high-order coefficient tables of aspheric surfaces are the same as Table 6-1 and Table 6-2 in Embodiment 5.

The numerical values of related parameters of the optical photographic lens assembly in this embodiment are shown in the ‘Embodiment 6’ column of Table 7, wherein specific descriptions of meanings represented by the parameters are the same as the descriptions in Embodiment 1, and thus details are not repeated herein again.

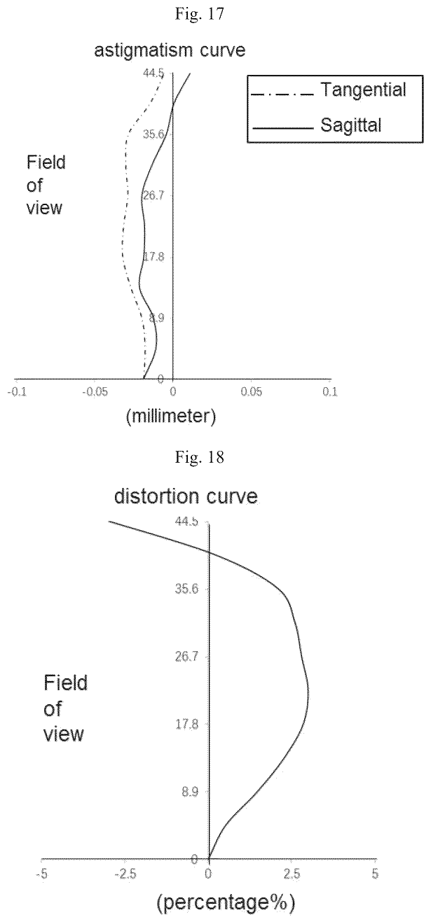

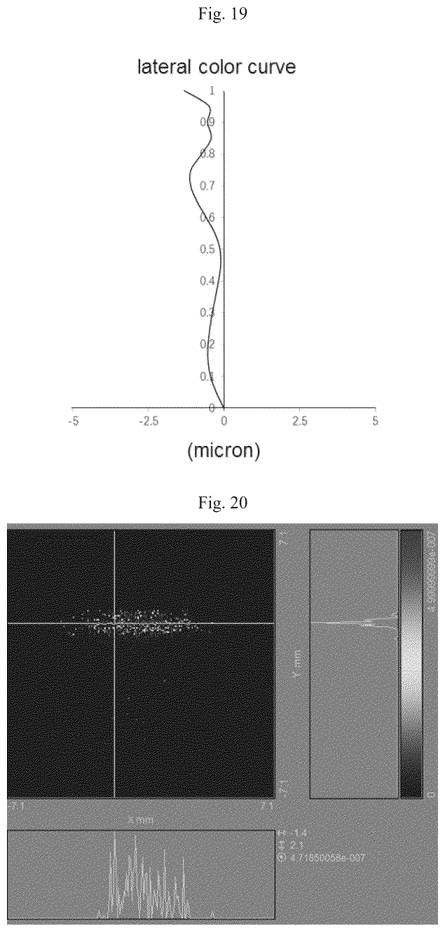

FIG. 16 illustrates longitudinal aberration curves of the optical photographic lens assemblies in Embodiment 5 and Embodiment 6, which represent deviations of focal points of rays of different wavelengths after passing through the optical photographic lens assembly. FIG. 17 illustrates astigmatism curves of the optical photographic lens assemblies in Embodiment 5 and Embodiment 6, which represent tangential image surface bending and sagittal image surface bending. FIG. 18 illustrates a distortion curve of the optical photographic lens assemblies in Embodiment 5 and Embodiment 6, which represents distortion values corresponding to different angles of field of view. FIG. 19 illustrates a lateral color curve of the optical imaging lenses in Embodiment 5 and Embodiment 6, which represents deviations of different image heights on the imaging surface after the light rays pass through the optical photographic lens assembly. It can be seen from FIG. 16 to FIG. 19 that the optical photographic lens assemblies provided in Embodiment 5 and Embodiment 6 may achieve good imaging quality.

TABLE 7

| | embodiment | | | | | |
|---|---|---|---|---|---|---|
| Parameter | Embodiment 1 | Embodiment 2 | Embodiment 3 | Embodiment 4 | Embodiment 5 | Embodiment 6 |
| d1s(mm) | 2.530 | 2.610 | 3.690 | 3.800 | 4.130 | 4.320 |
| D1s(mm) | 4.800 | 5.000 | 3.940 | 4.380 | 5.350 | 5.350 |
| D1m(mm) | 4.800 | 5.000 | 4.570 | 4.770 | 5.330 | 5.490 |
| D2s(mm) | 5.680 | 5.880 | 6.900 | 7.100 | 6.100 | 6.260 |
| d3m(mm) | 4.140 | 4.220 | 5.480 | 5.560 | 4.060 | 4.130 |
| d4s(mm) | 4.910 | 5.170 | 6.080 | 6.230 | 4.740 | 4.800 |
| d4m(mm) | 5.870 | 6.260 | 6.710 | 6.870 | 5.910 | 6.000 |
| D4s(mm) | 5.640 | 5.530 | 6.730 | 6.730 | 6.160 | 6.320 |
| d5s(mm) | 5.720 | 5.680 | 6.950 | 7.050 | 5.950 | 6.070 |
| d5m(mm) | 6.330 | 6.820 | 8.130 | 8.130 | 5.570 | 5.710 |
| D5m(mm) | 7.020 | 7.220 | 8.560 | 8.750 | 6.400 | 6.400 |
| d6m(mm) | 5.819 | 5.899 | 9.290 | 9.360 | 5.350 | 5.420 |
| D6m(mm) | 8.640 | 8.840 | 11.900 | 12.100 | 8.400 | 8.560 |
| CP2(mm) | 0.022 | 0.022 | 0.020 | 0.022 | 0.022 | 0.022 |
| CP3(mm) | 0.022 | 0.022 | 0.022 | 0.022 | 0.022 | 0.022 |
| CP4(mm) | 1.21 | 1.16 | 0.87 | 0.83 | 1.30 | 1.26 |
| CP5(mm) | 1.240 | 1.180 | 0.717 | 0.677 | 1.130 | 1.090 |
| EP01(mm) | 1.270 | 1.271 | 0.985 | 0.985 | 0.924 | 0.894 |
| EP34(mm) | 0.417 | 0.507 | 0.370 | 0.410 | 0.394 | 0.434 |
| EP45(mm) | 0.47 | 0.47 | 0.46 | 0.50 | 0.54 | 0.58 |
| EP56(mm) | 1.219 | 1.279 | 1.565 | 1.565 | 1.462 | 1.512 |

In addition, in Embodiment 1 to Embodiment 6, the effective focal lengths f1 to f7 of the first lens to the seventh lens are respectively shown in Table 8 below.

TABLE 8

| | embodiment | | | | | |
|---|---|---|---|---|---|---|
| Parameter | Embodiment 1 | Embodiment 2 | Embodiment 3 | Embodiment 4 | Embodiment 5 | Embodiment 6 |
| f1 (mm) | −147.32 | −147.32 | 13.63 | 13.63 | −28.06 | −28.06 |
| f2 (mm) | 22.08 | 22.08 | 11.87 | 11.87 | −503.98 | −503.98 |
| f3 (mm) | −10.01 | −10.01 | −6.39 | −6.39 | −15.13 | −15.13 |
| f4 (mm) | 4.63 | 4.63 | 5.38 | 5.38 | 6.67 | 6.67 |
| f5 (mm) | 10.11 | 10.11 | 123.60 | 123.60 | 3.96 | 3.96 |
| f6 (mm) | −11.78 | −11.78 | −31.57 | −31.57 | −7.02 | −7.02 |
| f7 (mm) | −33.46 | −33.46 | −15.77 | −15.77 | −12.30 | −12.30 |

Embodiment 1 to Embodiment 6 respectively satisfy the conditions shown in Table 9 below.

TABLE 9

| | embodiment | | | | | |
|---|---|---|---|---|---|---|
| Conditional expression | Embodiment 1 | Embodiment 2 | Embodiment 3 | Embodiment 4 | Embodiment 5 | Embodiment 6 |
| CT2/(T23 + CP2) | 2.23 | 2.23 | 4.40 | 4.36 | 1.13 | 1.13 |
| \|R1 × N1\|/d1s | 6.44 | 6.24 | 2.88 | 2.80 | 1.53 | 1.46 |
| (EP01 − CT1)/(CT1 + T12) | 0.39 | 0.39 | 0.10 | 0.10 | 0.39 | 0.36 |
| \|R2/D1s\| | 2.12 | 2.04 | 4.25 | 3.82 | 1.07 | 1.07 |
| R3/(D2s − D1m) | 14.13 | 14.13 | 7.33 | 7.33 | 15.35 | 15.35 |
| f3/(CT3 + CP2 + CP3) | −29.09 | −29.09 | −11.14 | −11.10 | −39.05 | −39.05 |
| \|R7/R6\| × (d4s/d3m) | 2.31 | 2.39 | 1.37 | 1.38 | 1.67 | 1.66 |
| CT4/(EP34 + CP4) | 0.79 | 0.77 | 1.01 | 1.01 | 0.72 | 0.72 |
| CP4/T45 | 4.05 | 3.88 | 12.49 | 11.91 | 19.59 | 18.98 |
| R8/d4s | −0.71 | −0.67 | −0.44 | −0.43 | −0.98 | −0.97 |
| \|R9/d4m\| | 2.54 | 2.38 | 2.22 | 2.17 | 2.41 | 2.38 |
| (EP45 + CP5)/CT5 | 1.61 | 1.55 | 2.24 | 2.24 | 0.84 | 0.84 |
| R11/\|d5s − d5m\| | 11.53 | 6.17 | 5.85 | 6.39 | 8.24 | 8.70 |
| R12/D5m | 0.50 | 0.49 | 0.55 | 0.54 | 0.27 | 0.27 |
| T67/EP56 + T67/CT7 | 4.17 | 4.11 | 6.23 | 6.23 | 5.29 | 5.25 |
| f6/f7 | 0.35 | 0.35 | 2.00 | 2.00 | 0.57 | 0.57 |
| \|R13/d6m\| | 0.68 | 0.67 | 0.55 | 0.55 | 0.49 | 0.48 |
| \|R14\|/(D6m − d6m) | 1.83 | 1.75 | 1.22 | 1.16 | 1.45 | 1.40 |

The disclosure further provides an imaging apparatus, which is provided with an electronic photosensitive element for imaging, wherein the electronic photosensitive element thereof is a charge coupled device (CCD) or a complementary metal oxide semiconductor (CMOS). The imaging apparatus is an independent imaging device such as a digital camera, and is an imaging module integrated on a mobile electronic device such as a mobile phone. The imaging apparatus is equipped with the optical photographic lens assembly described above.

The above description is only illustration of preferred embodiments of the disclosure and applied technical principles. It should be understood by those skilled in the art that the invention scope involved in the disclosure is not limited to technical solutions formed by specific combinations of the above technical features, and should also cover other technical solutions formed by any combination of the above technical features or equivalent features thereof without departing from the inventive concept, for example, technical solutions formed by replacing the above features with technical features having similar functions disclosed in the disclosure (but not limited to).

What is claimed is:

1. An optical photographic lens assembly, comprising a lens group and at least one spacing element, wherein
the lens group comprises a first lens, a second lens, a third lens, a fourth lens, a fifth lens, a sixth lens and a seventh lens, which are sequentially arranged from an object side to an image side along an optical axis;
there is an air gap between any two adjacent lenses among the first lens to the seventh lens;
the first lens to the seventh lens comprise at least one aspheric lens;
there are seven lenses having refractive powers in the optical photographic lens assembly;
the at least one spacing element comprises: a fourth spacing element, located between the fourth lens and the fifth lens and in contact with an image-side surface of the fourth lens;
the optical photographic lens assembly satisfies:
$$3.85 < CP 4 / T 45 < 19.6 ;$$
$$- 1. < R 8 / d 4 s < - 0.4 ; and$$
$$2.15 < \vert R 9 / d 4 m \vert < 2.55 ,$$
wherein CP4 is a maximum thickness of the fourth spacing element along the optical axis, T45 is an air gap between the fourth lens and the fifth lens on the optical axis, R8 is a radius of curvature of the image-side surface of the fourth lens, d4s is an inner diameter of an object-side surface of the fourth spacing element, R9 is a radius of curvature of an object-side surface of the fifth lens, and d4m is an inner diameter of an image-side surface of the fourth spacing element.

2. The optical photographic lens assembly according to claim 1, wherein the at least one spacing element further comprises: a second spacing element, located between the second lens and the third lens and in contact with an image-side surface of the second lens; and
a center thickness CT2 of the second lens on the optical axis, an air gap T23 between the second lens and the third lens on the optical axis, and a maximum thickness CP2 of the second spacing element along the optical axis satisfy:
$$1.1 < CT 2 / ( T 23 + CP 2 ) \leq 4.4 .$$

3. The optical photographic lens assembly according to claim 1, wherein the at least one spacing element further comprises: a first spacing element, located between the first lens and the second lens and in contact with an image-side surface of the first lens; and
a radius of curvature R1 of an object-side surface of the first lens, a refractive index N1 of the first lens, and an inner diameter d1s of an object-side surface of the first spacing element satisfy:
$$1.4 < \vert R 1 \times N 1 \vert / d 1 s < 6.5 .$$

4. The optical photographic lens assembly according to claim 1, wherein the optical photographic lens assembly further comprises a lens barrel, and the lens group and the at least one spacing element are assembled in the lens barrel; the at least one spacing element further comprises a first spacing element, located between the first lens and the second lens and in contact with an image-side surface of the first lens; and
a distance EP01 from an object-side end surface of the lens barrel to an object-side surface of the first spacing element on the optical axis, a center thickness CT1 of the first lens on the optical axis, and an air gap T12 between the first lens and the second lens on the optical axis satisfy:
$$0.1 \leq ( EP 01 - CT 1 ) / ( CT 1 + T 12 ) \leq 0.4 .$$

5. The optical photographic lens assembly according to claim 1, wherein the at least one spacing element further comprises: a first spacing element, located between the first lens and the second lens and in contact with an image-side surface of the first lens; and
a radius of curvature R2 of the image-side surface of the first lens and an outer diameter D1s of an object-side surface of the first spacing element satisfy:
$$1.05 < \vert R 2 / D 1 s \vert < 4.3 .$$

6. The optical photographic lens assembly according to claim 1, wherein the at least one spacing element further comprises: a first spacing element, located between the first lens and the second lens and in contact with an image-side surface of the first lens, and a second spacing element, located between the second lens and the third lens and in contact with an image-side surface of the second lens; and
a radius of curvature R3 of an object-side surface of the second lens, an outer diameter D2s of an object-side surface of the second spacing element, and an outer diameter D1m of an image-side surface of the first spacing element satisfy:
$$7.3 < R 3 / ( D 2 s - D 1 m ) < 15.4 .$$

7. The optical photographic lens assembly according to claim 1, wherein the at least one spacing element further comprises: a second spacing element, located between the second lens and the third lens and in contact with an image-side surface of the second lens, and a third spacing element, located between the third lens and the fourth lens and in contact with an image-side surface of the third lens; and
an effective focal length f3 of the third lens, a center thickness CT3 of the third lens on the optical axis, a maximum thickness CP2 of the second spacing element along the optical axis, and a maximum thickness CP3 of the third spacing element along the optical axis satisfy:
$$- 39.1 < f 3 / ( CT 3 + CP 2 + CP 3 ) \leq - 11. .$$

8. The optical photographic lens assembly according to claim 1, wherein,
the first lens has a positive refractive power or a negative refractive power;
the second lens has a positive refractive power or a negative refractive power, and an object-side surface of the second lens is a convex surface;
the third lens has a negative refractive power, and an object-side surface of the third lens is a concave surface;
the fourth lens has a positive refractive power, and the image-side surface of the fourth lens is a convex surface;
the fifth lens has a positive refractive power, and an image-side surface of the fifth lens is a convex surface;
the sixth lens has a negative refractive power, an object-side surface of the sixth lens is a convex surface, and an image-side surface of the sixth lens is a concave surface; and
the seventh lens has a negative refractive power.

9. The optical photographic lens assembly according to claim 1, wherein the at least one spacing element further comprises: a third spacing element, located between the third lens and the fourth lens and in contact with an image-side surface of the third lens, and the fourth spacing element, located between the fourth lens and the fifth lens and in contact with the image-side surface of the fourth lens; and
a radius of curvature R7 of an object-side surface of the fourth lens, a radius of curvature R6 of the image-side surface of the third lens, the inner diameter d4s of the object-side surface of the fourth spacing element, and an inner diameter d3m of an image-side surface of the third spacing element satisfy:
$$1.35 < \vert R 7 / R 6 \vert \times ( d 4 s / d 3 m ) \leq 2.4 .$$

10. The optical photographic lens assembly according to claim 1, wherein the at least one spacing element further comprises: a third spacing element, located between the third lens and the fourth lens and in contact with an image-side surface of the third lens, and the fourth spacing element, located between the fourth lens and the fifth lens and in contact with the image-side surface of the fourth lens; and
a center thickness CT4 of the fourth lens on the optical axis, a distance EP34 from an image-side surface of the third spacing element to an object-side surface of the fourth spacing element on the optical axis, and the maximum thickness CP4 of the fourth spacing element along the optical axis satisfy:
$$0.7 < CT 4 / ( EP 34 + CP 4 ) < 1.05 .$$

11. The optical photographic lens assembly according to claim 1, wherein the at least one spacing element further comprises: the fourth spacing element, located between the fourth lens and the fifth lens and in contact with the image-side surface of the fourth lens, and a fifth spacing element, located between the fifth lens and the sixth lens and in contact with an image-side surface of the fifth lens; and
a distance EP45 from an image-side surface of the fourth spacing element to an object-side surface of the fifth spacing element on the optical axis, a maximum thickness CP5 of the fifth spacing element along the optical axis, and a center thickness CT5 of the fifth lens on the optical axis satisfy:
$$0.8 < ( EP 45 + CP 5 ) / CT 5 < 2.3 .$$

12. The optical photographic lens assembly according to claim 1, wherein the at least one spacing element further comprises: a fifth spacing element, located between the fifth lens and the sixth lens and in contact with an image-side surface of the fifth lens; and
a radius of curvature R11 of an object-side surface of the sixth lens, an inner diameter d5s of an object-side surface of the fifth spacing element, and an inner diameter d5m of an image-side surface of the fifth spacing element satisfy:
$$5.8 < R 11 / \vert d 5 s - d 5 m \vert < 11.6 .$$

13. The optical photographic lens assembly according to claim 1, wherein the at least one spacing element further comprises: a fifth spacing element, located between the fifth lens and the sixth lens and in contact with an image-side surface of the fifth lens; and
a radius of curvature R12 of an image-side surface of the sixth lens and an outer diameter D5m of an image-side surface of the fifth spacing element satisfy:
$$0.25 < R 12 / D 5 m < 0.6 .$$

14. The optical photographic lens assembly according to claim 1, wherein the at least one spacing element further comprises: a fifth spacing element, located between the fifth lens and the sixth lens and in contact with an image-side surface of the fifth lens, and a sixth spacing element, located between the sixth lens and the seventh lens and in contact with an image-side surface of the sixth lens; and
an air gap T67 between the sixth lens and the seventh lens on the optical axis, a distance EP56 from an image-side surface of the fifth spacing element to an object-side surface of the sixth spacing element on the optical axis, and a center thickness CT7 of the seventh lens on the optical axis satisfy:
$$4.1 < T 67 / EP 56 + T 67 / CT 7 < 6.3 .$$

15. The optical photographic lens assembly according to claim 1, wherein an effective focal length f6 of the sixth lens and an effective focal length f7 of the seventh lens satisfy:
$$0.33 < f 6 / f 7 \leq 2. .$$

16. The optical photographic lens assembly according to claim 1, wherein the at least one spacing element further comprises: a sixth spacing element, located between the sixth lens and the seventh lens and in contact with an image-side surface of the sixth lens; and
a radius of curvature R13 of an object-side surface of the seventh lens and an inner diameter d6m of an image-side surface of the sixth spacing element satisfy:
$$0.45 < \vert R 13 / d 6 m \vert \leq 0.7 .$$

17. The optical photographic lens assembly according to claim 1, wherein the at least one spacing element further comprises: a sixth spacing element, located between the sixth lens and the seventh lens and in contact with an image-side surface of the sixth lens; and
a radius of curvature R14 of an image-side surface of the seventh lens, an outer diameter Dom of an image-side surface of the sixth spacing element, and an inner diameter d6m of the image-side surface of the sixth spacing element satisfy:
$$1.14 < \vert R 14 \vert / ( D 6 m - d 6 m ) \leq 1.85 .$$
